(19) United States
(12) Patent Application Publication
(10) Pub. No.: US 2003/0140163 A1
(43) Pub. Date: Jul. 24, 2003

(54) Low-processor-load aggregation

(75) Inventors: Joel D. Peshkin, San Juan Capistrano, CA (US); Alexey E. Pynko, Irvine, CA (US); Michael C. Whitfield, Valbonne (FR)

Correspondence Address: SEED INTELLECTUAL PROPERTY LAW GROUP PLLC, 701 FIFTH AVE, SUITE 6300, SEATTLE, WA, 98104-7092, US

(73) Assignee: Conexant Systems, Inc., Newport Beach, CA

(21) Appl. No.: 10/055,597

(22) Filed: Jan. 22, 2002

(51) Int. Cl. G06F 15/173

(52) U.S. Cl. 709/238

(57) ABSTRACT

In one embodiment, a system includes but is not limited to a low-processor-load aggregation device interposed between a network and at least one network station, the low-processor-load aggregation device having: (a) at least one multi-channel device, the multi-channel device having at least one internal network tag associated with the at least one network station, and (b) a host-processor-controlled routing device operably coupled with the network, the host-processor-controlled routing device configured to coordinate at least one network address with the at least one internal network tag associated with the at least one network station. In another embodiment, a method includes but is not limited to coordinating an external network-station packet with an internal private-network address of a low-processor-load aggregation device. In one embodiment, a method includes but is not limited to coordinating an external network-station control message with an internal private-network address of a low-processor-load aggregation device. In one or more various embodiments, related systems include but are not limited to circuitry and/or programming for effecting the foregoing-referenced method embodiments; the circuitry and/or programming can be virtually any combination of hardware, software, and/or firmware configured to effect the foregoing-referenced method embodiments depending upon the design choices of the system designer.

### CROSS-REFERENCE TO RELATED APPLICATION

This patent application incorporates by reference in its entirety the subject matter of the currently co-pending U.S. patent application entitled, Assigning Addresses to Packet-Network Devices and Booting Multi-Channel Devices, naming Joel D. Peshkin, Alexey E. Pynko, and Michael C. Whitfield as inventors, filed substantially contemporaneously herewith.

### BACKGROUND OF THE INVENTION

1. Field of the Invention

The present application relates, in general, to data communications involving at least one data communications network.

2. Description of the Related Art

Data communications is the transfer of data from one or more sources to one or more sinks that is accomplished (a) via one or more data links between the one or more sources and one or more sinks and (b) according to a protocol. Weik, Communications Standard Dictionary 203 (3rd ed. 1996). A data communications network is the interconnection of two or more communicating entities (i.e., data sources and/or sinks) over one or more data links. Weik, Communications Standard Dictionary 618 (3rd ed. 1996).

With reference to the figures, and in particular with reference now to FIG. 1A, shown are a packet-switched network 100 and a circuit-switched network 102. Depicted is an aggregation device 104 interposed between the packet-switched network 100 and the circuit-switched network 102. Illustrated are a Personal Computing (PC) device 108 and a voice device 112, both of which are shown interfaced with the aggregation device 104 via the circuit switched network 102.

Referring now to FIG. 1B, depicted is the block diagram of FIG. 1A showing the aggregation device 104 in an exploded view. Illustrated internal to the aggregation device 104 are a host processor 114, and multi-line bus (e.g., a Peripheral Component Interconnect (PCI) bus) devices 118, connected with a multi-line bus (e.g., a PCI bus) 116. In operation, all data that transit the aggregation device 104 must be processed by and transit the host processor 114. For example, with respect to data transiting the aggregation device in a direction from the circuit-switched network 102 to the packet-switched network 100, the host processor 114 generally determines whether each multi-line bus device 118 has data via polling (e.g., “round robin” polling). If the polling does indicate that data are present at a particular multi-line bus device 118, the host processor 104 then directs that particular multi-line bus device 118 to deliver data to the host processor 104 via multi-line bus 116. Thereafter, the host processor 104 processes the received data as appropriate and subsequently transmits packetized data out over the packet-switched network 100. As another example, with respect to data transiting the aggregation device in a direction from the packet-switched network 100 to the circuit-switched network 102, the host processor 114 generally receives packetized data from the packet-switched network 100. Thereafter, the host processor 114 processes the received packetized data as appropriate and transmits the processed data to the appropriate multi-line bus device 118 via the multi-line bus 116.

The inventors have recognized that, insofar as in the related art all data transiting aggregation device 104 transits the host processor 114, the host processor 114 serves as a bottleneck for data transmission.

### BRIEF SUMMARY OF THE INVENTION

In one embodiment, a system includes but is not limited to a low-processor-load aggregation device interposed between a network and at least one network station, said low-processor-load aggregation device having: (a) at least one multi-channel device, said multi-channel device having at least one internal network tag associated with the at least one network station, and (b) a host-processor-controlled routing device operably coupled with the network, said host-processor-controlled routing device configured to coordinate at least one network address with the at least one internal network tag associated with the at least one network station.

In one embodiment, a method includes but is not limited to coordinating an external network packet with an internal private-network address of a low-processor-load aggregation device. In another embodiment of the method, said coordinating an external network packet with an internal private-network address of the low-processor-load aggregation device is characterized by coordinating the external network packet with at least one internal private-network address of at least one multi-channel device. In another embodiment of the method, said coordinating the external network packet with at least one internal private-network address of at least one multi-channel device is characterized by coordinating the external network packet with the at least one internal private-network address on the basis of a content of the external network packet. In another embodiment of the method, said coordinating the external network packet with the at least one internal private-network address on the basis of a content of the external network packet is characterized by coordinating the external network address with an internal private-network address on the basis of a Voice-Over-IP, Modem-Over-IP, or Fax-Over-IP content of the external network packet. In another embodiment of the method, said coordinating the external network packet with at least one internal private-network address of at least one multi-channel device is characterized by coordinating the external network packet with the at least one internal private-network address on the basis of a header of the external network packet. In another embodiment of the method, coordinating an external network address of the packet with at least one internal private-network address of at least one multi-channel device is characterized by coordinating the external network address with at least one internal private-network device uniquely associated with the at least one multi-channel device. In another embodiment of the method, said coordinating an external network address of the packet with at least one internal private-network address of at least one multi-channel device is characterized by coordinating the external network address with at least one VLAN tag internal to the at least one multi-channel device. In another embodiment of the method, said coordinating the external network address with at least one VLAN tag internal to the at least one multi-channel device is characterized by coordinating the external network address with at least one VLAN tag internal to the at least one multi-channel device, where the at least one VLAN tag is associated with a channel unit maintaining a logical channel with at least one network station. In another embodiment of the method, the network station comprises a network station selected from the network-station group including but not limited to a PC device, a voice device, and a fax device In another embodiment of the method, said coordinating an external network packet with an internal private-network address of a low-processor-load aggregation device is characterized by coordinating the external network address with an internal private-network address of a host processor. In another embodiment of the method, said coordinating the external network address with an internal private-network address of a host processor is characterized by directing at least a part of a packet having the external network address to the internal private-network address of the host processor. In another embodiment of the method, said coordinating the external network address with an internal private-network address of a host processor is characterized by directing at least a part of a packet having the external network address to a channel unit internal to the internal private-network address of the host processor. In another embodiment of the method, the internal private-network address is characterized by an Ethernet-protocol address. In addition to the foregoing, other method embodiments are described in the claims, drawings, and text forming a part of the present application.

In one or more various embodiments, related systems include but are not limited to circuitry and/or programming for effecting the foregoing-referenced method embodiments; the circuitry and/or programming can be virtually any combination of hardware, software, and/or firmware configured to effect the foregoing-referenced method embodiments depending upon the design choices of the system designer.

In one embodiment, a method includes but is not limited to coordinating an external network-station packet with at least one internal private-network address of at least one multi-channel device. In another embodiment of the method, said coordinating an external network-station packet with at least one internal private-network address of at least one multi-channel device is characterized by coordinating the external network-station packet with the at least one internal private-network address on the basis of a content of the external network-station packet. In another embodiment of the method, said coordinating the external network-station packet with the at least one internal private-network address on the basis of a content of the external network-station packet is characterized by coordinating the external network-station address with an internal private-network address of a host processor on the basis of a content of the external network-station packet. In another embodiment of the method, said coordinating the external network-station address with an internal private-network address of a host processor on the basis of a content of the external network-station packet is characterized by coordinating the external network-station address with an internal private-network address of a host processor on the basis of a PPP control command content of the external network-station packet. In another embodiment of the method, said coordinating the external network-station packet with the at least one internal private-network address on the basis of a content of the external network-station packet is characterized by coordinating the external network-station address with an internal private-network address of a routing device on the basis of a header of the external network-station packet. In another embodiment of the method, the internal private-network address is characterized by an Ethernet-protocol address. In addition to the foregoing, other method embodiments are described in the claims, drawings, and text forming a part of the present application.

In one or more various embodiments, related systems include but are not limited to circuitry and/or programming for effecting the foregoing-referenced method embodiments; the circuitry and/or programming can be virtually any combination of hardware, software, and/or firmware configured to effect the foregoing-referenced method embodiments depending upon the design choices of the system designer.

In one embodiment, a method includes but is not limited to coordinating an external network-station control message with an internal private-network address of a low-processor-load aggregation device. In another embodiment of the method, said coordinating an external network-station control message with an internal private-network address of a low-processor-load aggregation device is characterized by coordinating the external network-station control message with the at least one internal private-network address. In another embodiment of the method, the control message comprises a PPP control message. In another embodiment of the method, the internal private-network address is characterized by an Ethernet-protocol address. In addition to the foregoing, other method embodiments are described in the claims, drawings, and text forming a part of the present application.

In one or more various embodiments, related systems include but are not limited to circuitry and/or programming for effecting the foregoing-referenced method embodiments; the circuitry and/or programming can be virtually any combination of hardware, software, and/or firmware configured to effect the foregoing-referenced method embodiments depending upon the design choices of the system designer.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the non-limiting detailed description set forth herein.

### BRIEF DESCRIPTION OF THE SEVERAL VIEWS OF THE DRAWING(S)

FIG. 1A shows a packet-switched network 100 and a circuit-switched network 102.

FIG. 1B depicts the block diagram of FIG. 1A showing the aggregation device 104 in an exploded view.

FIG. 2 shows the block diagram of FIG. 1B, modified to depict a low-processor-load aggregation device 250 interposed between the packet-switched network 100 and the circuit-switched network 102.

FIG. 8A shows a host processor 202 operably coupled (e.g., via a coaxial cable) with a broadcast-capable switch 204 (e.g., an Ethernet bridge, switch, or hub).

FIG. 8B depicts that the host processor 202 has directed the broadcast-packet-processing devices 216, 226, 236 to enter an ignore-initial-address-assignment mode via placing “ignore” values on all attend-ignore lines 810, 820, 830.

FIG. 8C illustrates that the host processor 202 has directed a broadcast-packet-processing device 216 to enter a process-initial-address-assignment mode via placing an “attend” value on that first broadcast-packet-processing device's 216 attend-ignore line 810.

FIG. 8D shows that the host processor 202 has transmitted a broadcast packet containing payload having a first address-assignment message (e.g., a message that an Ethernet device is to be assigned a MAC address), which the broadcast-capable switch 204 has routed onto shared medium 255.

FIG. 8E depicts that the broadcast-packet-processing device 216 having an “attend” value on its attend-ignore line 810 processes the broadcast packet and passes the first-address assignment message to its address-assignment-recognition device 812.

FIG. 8F illustrates that the host processor 202 has directed a second broadcast-packet-processing devices 226 to enter a process-initial-address-assignment mode via placing an “attend” value on that second broadcast-packet-processing device's 226 attend-ignore line 820.

FIG. 8G shows that the host processor 202 has transmitted a broadcast packet containing payload having a second address-assignment message, which the broadcast-capable switch 204 has routed onto shared medium 255.

FIG. 8H depicts that the first and second broadcast-packet-processing devices 216, 226 respectively having an “attend” value on their attend-ignore lines 810, 820, respectively process the broadcast packet and pass the second address-assignment message to their respective internal address-assignment-recognition devices 812, 822.

FIG. 8I shows that the address-assignment-recognition device (e.g., MAC address-assignment-recognition device) 822 has an assignment status equal to “second-address assigned”, and that its associated broadcast-packet-processing device (e.g., Ethernet device) 226 has an address status equal to second-address as a result of the operations described in relation to FIG. 8E.

FIG. 8J shows an alternate embodiment of the system shown in FIG. 8A.

FIG. 9A shows multi-channel devices 218, 228, 238 in the context of a system wherein packet-processing devices 216, 226, 236 have pre-assigned addresses.

FIG. 9B shows that in one implementation, when multi-channel channel device 218 having slaved initial boot packet processing device 910 has respectively booted, slaved initial boot packet processing device 910 transmits a packet having a destination address of the host processor 202 and a source address of the packet-processing device 216.

FIG. 3A shows a standard routing device 210 receiving an inbound packet 300 having payload containing voice (e.g., voice over IP) contents of a type which the low-processor-load aggregation device 210 is expected to process (rather than just pass on).

FIG. 3B depicts that upon receipt of the Ethernet frame 302, the device having the MAC address of the Ethernet frame 302 strips the Ethernet header and hands the residual VLAN-tagged packet 304 into multi-channel device 228.

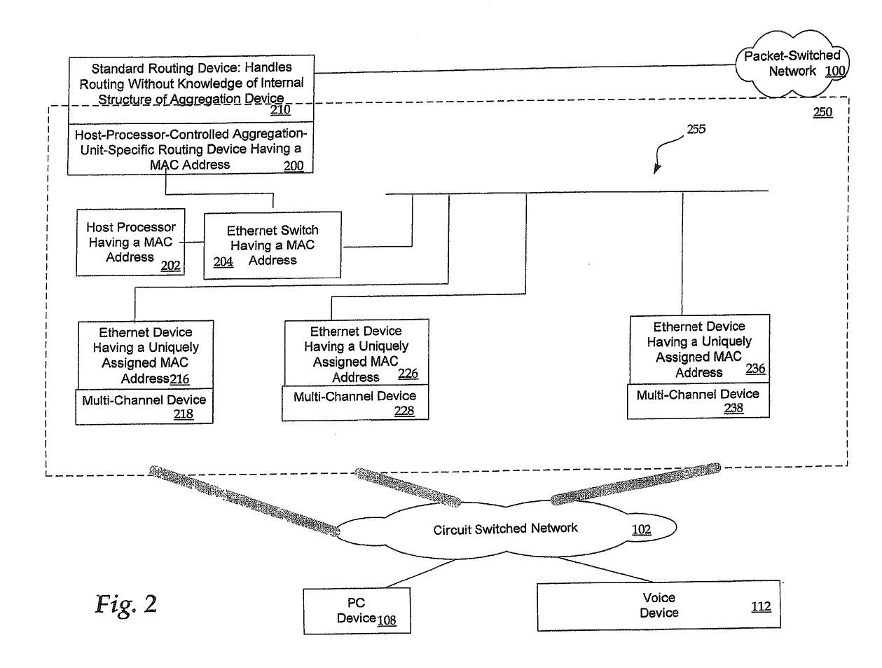

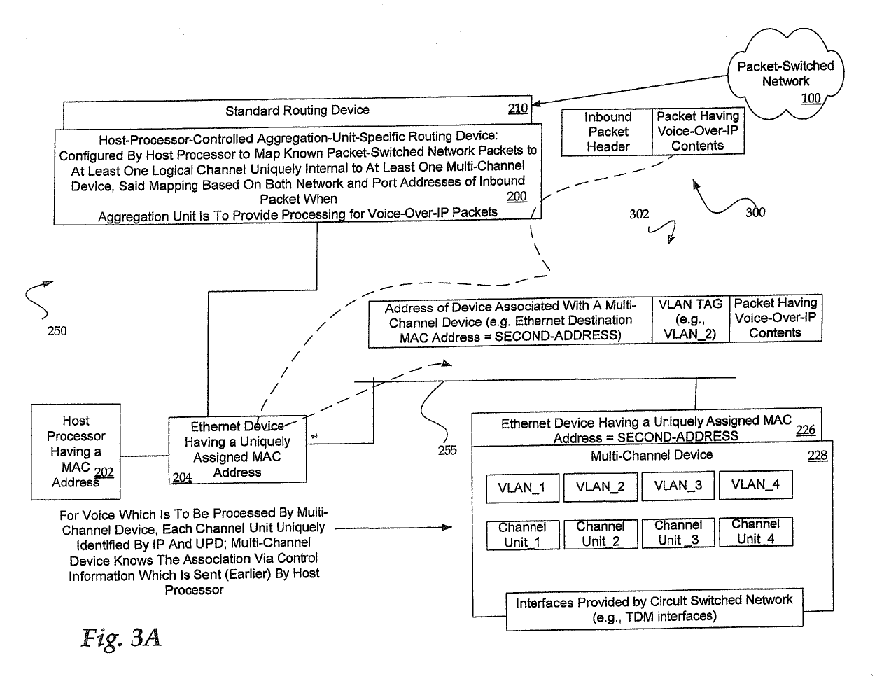

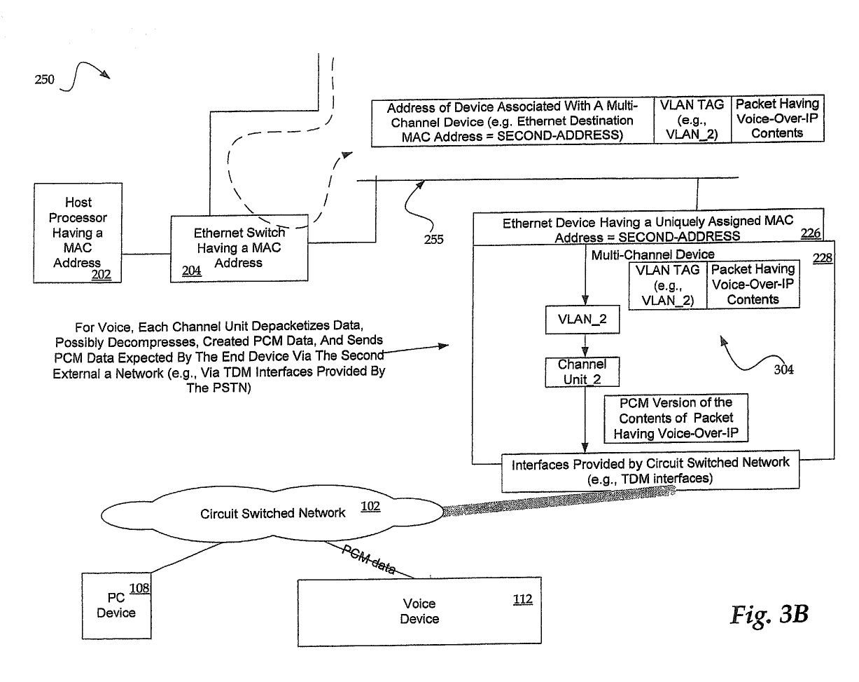

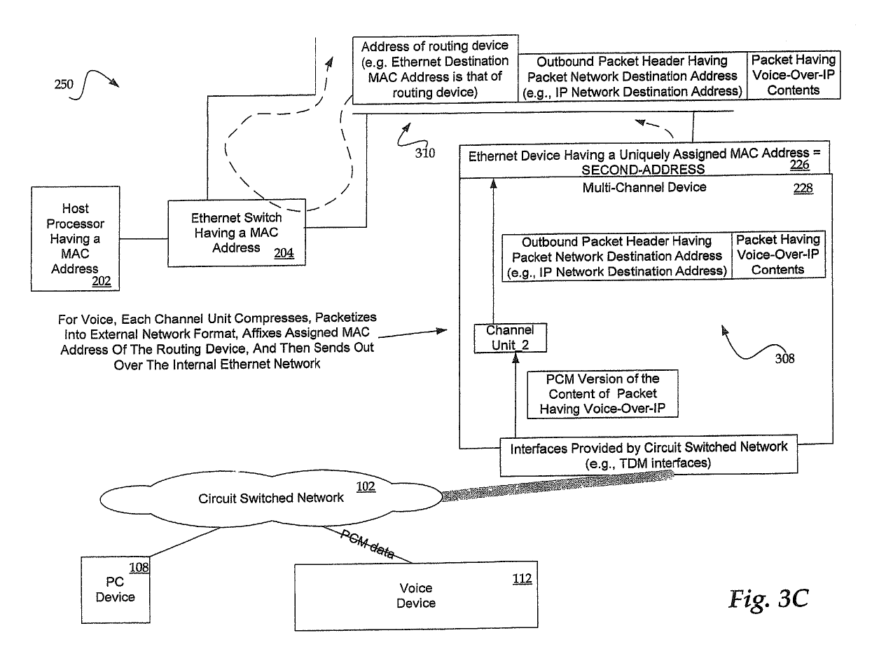

FIG. 3C depicts that upon receipt of the PCM data from the voice device 112, the channel unit (e.g., channel unity_2) converts the PCM data into an outbound voice-over-IP packet 308 appropriately addressed to and bound for the external packet-switched network 100 (FIG. 2) and thereafter hands the voice-over-IP packet 308 to the Ethernet device 226, which encapsulates the voice-over-IP packet 308 into an Ethernet frame 310 which has as its destination address the MAC address of the host-processor-controlled aggregation-unit-specific routing device 200.

FIG. 3D illustrates that Ethernet switch 204 switches Ethernet frame 310 to host-processor-controlled aggregation-unit-specific routing device 200.

FIG. 4A shows the standard routing device 210 receiving an inbound-packet 400, where the inbound-packet 400 has payload which low-processor-load aggregation device 250 is not expected to process.

FIG. 4B depicts that upon receipt of the Ethernet frame 402, the device having the MAC address of the Ethernet frame 402 strips the Ethernet header and hands the residual VLAN-tagged packet 404 into multi-channel device 228. Multi-channel device 228 delivers VLAN-tagged packet 404 to the VLAN unit (e.g., VLAN Unit_3 as shown in FIG. 4B) identified by the VLAN tag of the VLAN-tagged packet 404.

FIG. 4C depicts that upon receipt of an outbound packet 408 appropriately addressed to and bound for the external packet-switched network 100 (FIG. 2), multi-channel device 228 hands the outbound packet 408 to the Ethernet device 226, which encapsulates the outbound packet 408 into an Ethernet frame 410 which has as its destination address the MAC address of the host-processor-controlled aggregation-unit-specific routing device 200.

FIG. 4D illustrates that Ethernet switch 204 switches Ethernet frame 410 to host-processor-controlled aggregation-unit-specific routing device 200.

FIGS. 4E-4F show the situation where the PC device 108 is expecting the low-processor-load aggregation device 250 to provide some control functions related to the NCP and LCP control aspects of the PPP protocol.

FIG. 5 shows a high-level block diagram depicting an implementation of a method, in the context of the low-processor-load aggregation device 250, wherein control information is routed to the host processor 202.

FIG. 6A shows a high-level logic flowchart depicting a method and system.

FIG. 6B depicts that the channel unit passes the payload 602 to the attached Ethernet device 226 with instructions that payload be encapsulated in an Ethernet frame 604 having the MAC address of the host processor 202 and thereafter transmits the Ethernet frame 604 via the Ethernet bus 255.

FIG. 7A shows that the host processor 202 causes an Ethernet frame 700, having control information destined for the host processor's 202 counterpart—which not shown, but which is somewhere out in the packet-switched network 100—to be transmitted, via Ethernet switch 204, out onto the Ethernet bus 255.

FIG. 7B depicts that the channel unit passes the payload 702 to its associated VLAN unit (e.g., VLAN Unit_2, which is illustrated as associated with the channel unit_2), which creates a VLAN-tagged packet 704.

The use of the same symbols in different drawings typically indicates similar or identical items.

### DETAILED DESCRIPTION OF THE INVENTION

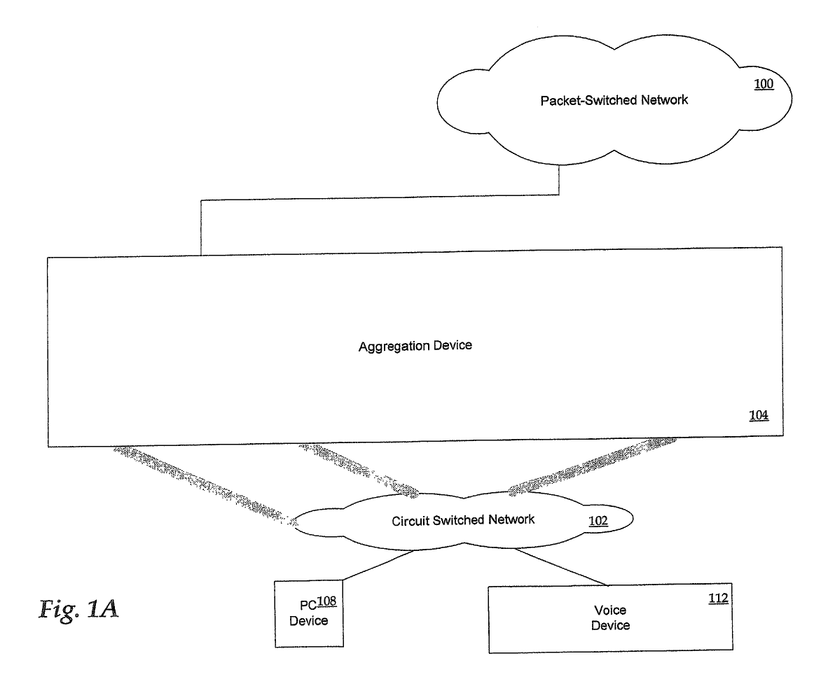

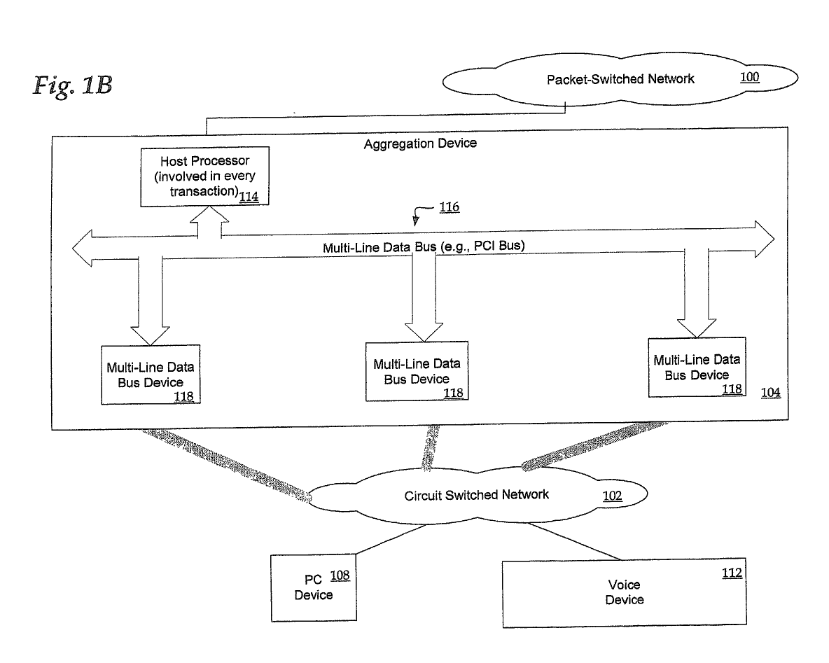

Referring now to FIG. 2, shown is the block diagram of FIG. 1B, modified to depict a low-processor-load aggregation device 250 interposed between the packet-switched network 100 and the circuit-switched network 102. Depicted is that the low-processor-load aggregation device 250 interfaces with a standard routing device 210, which as shown handles routing without any knowledge of the internal structure of the-low-processor-load aggregation device 250. The standard routing device 210 is shown spanning the boundary of the-low-processor-load aggregation device 250 in order to illustrate that in some implementations, the-low-processor-load aggregation device 250 can be made backwards compatible with legacy routing devices and networks having no knowledge of the-low-processor-load aggregation device 250, while in other implementations the-low-processor-load aggregation device 250 can be implemented as integral with a routing device having the functionality of both the standard routing device 210 and a host-processor-controlled aggregation-unit-specific routing device 200 (e.g., via a legacy routing device whose control code has been modified to actively interact with the host-processor-controlled aggregation-unit-specific routing device 200, or via a newly produced routing device having the functionality of both the standard routing device 210 and the host-processor-controlled aggregation-unit-specific routing device 200). However, for sake of conceptual clarity the standard routing device 210 is described herein as functionally separate from the host-processor-controlled aggregation-unit-specific routing device 200 in order to most clearly highlight the operation of each component.

Depicted is that the host-processor-controlled aggregation-unit-specific routing device 200 is interposed between the standard routing device 210 and an Ethernet switch 204. While an Ethernet protocol switch is described herein for sake of conceptual clarity, those having ordinary skill in the art will appreciate that other like switches can be substituted for the Ethernet switch 204 via a minimum degree of experimentation well within the ambit of one having ordinary skill in the art. In various implementations, host-processor-controlled aggregation-unit-specific routing device 200 is controlled by the host processor 202 to add/remove headers to packets in various fashions described following.

Shown is that the Ethernet switch 204 is connected to an Ethernet bus 255. Those having ordinary skill in the art will recognize that while the Ethernet bus 255 is described herein as a shared-medium bus for sake of conceptual clarity, the teachings herein may be adapted to non-shared medium buses (e.g., non-shared medium Ethernet buses), via a minimum amount of experimentation well within the ambit of one having ordinary skill in the art.

Those skilled in the art will appreciate that, for sake of conceptual clarity, the low-processor-load aggregation device 250 is illustrated herein as being composed of a “hybrid” network. That is, the host processor 202 and the host-processor-controlled aggregation-unit-specific routing device 200 are shown herein as being attached to non-shared mediums each of which is attached to unique ports of the switch 204, while the remaining Ethernet devices 216, 226, 236 are shown herein as being attached to a shared medium 255, where shared medium 255 is shown attached to a unique port of the switch 204. Although low-processor-load aggregation unit 250 is illustrated herein as being composed of a hybrid system, those skilled in the art will appreciate that the low-processor-load aggregation unit 250 is also illustrative of non-hybrid systems. For example, those skilled in the art will appreciate that the low-processor-load aggregation unit 250 is also illustrative of non-hybrid “shared medium” systems where host processor 202, the host-processor-controlled aggregation-unit-specific routing device 200, and the remaining Ethernet devices 216, 226, 236 are all attached to a shared medium 255 (thereby obviating the requirement for switch 204). As another example, those skilled in the art will appreciate that the low-processor-load aggregation unit 250 is also illustrative of non-hybrid “switched” systems wherein the host processor 202, the host-processor-controlled aggregation-unit-specific routing device 200, and the remaining Ethernet devices 216, 226, 236 are each respectively individually attached to their own non-shared mediums, where each non-shared medium respectively attaches to a unique port of the switch 204. Either or both of the foregoing non-hybrid systems can be implemented in light of the teachings herein via minimal experimentation well within the ambit of one having ordinary skill in the art.

Continuing to refer to FIG. 2, further depicted as connected to the Ethernet bus 255 are the Ethernet devices 216, 226, 236, each of which is shown to have a uniquely assigned Media Access Control (MAC) address. Illustrated as respectively uniquely connected with each of the Ethernet devices 216, 226, 236, are multi-channel devices 218, 228, 238. Depicted is that each multi-channel device may access interfaces provided by the underlying circuit switched network, as necessary, in order to establish and support at least one end of a channel, the opposite end of which is expected to be provided by some network-station device (e.g., PC device 108, or voice device 112) across an underlying intervening network (e.g., the underlying circuit-switched network 102). While FIG. 2, the other figures herein, and their attendant discussions only describe two network-station devices (e.g., the PC device 108 and the voice device 112) interfacing with one of the multi-channel devices 218, 228, 238, those having ordinary skill in the art will appreciate that, in normal operation, each multi-channel device 218, 228, 238 will typically be interfacing with and providing channel support to many (e.g., tens or hundreds) network station devices simultaneously. Those skilled in the art will appreciate that the reason why only two network-station devices are shown and described herein is merely for sake of conceptual clarity.

As has been described in relation to FIG. 2, it is preferable that the MAC address of each Ethernet device 216, 226, 236 be uniquely assigned. There are many ways in which such assignment may be done, but one way in which such assignment may be done is illustrated immediately following.

I. Assigning Addresses to Packet-Network Devices

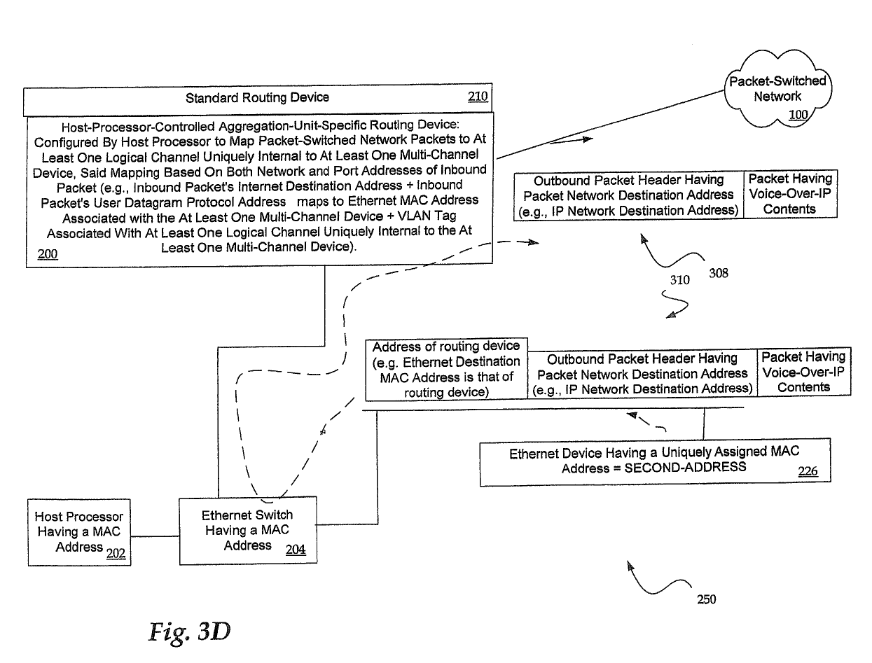

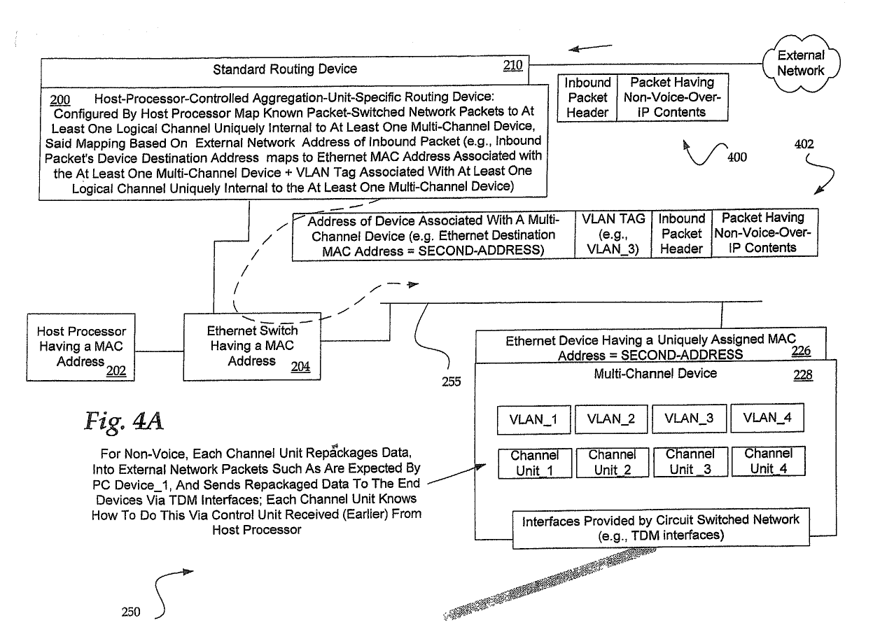

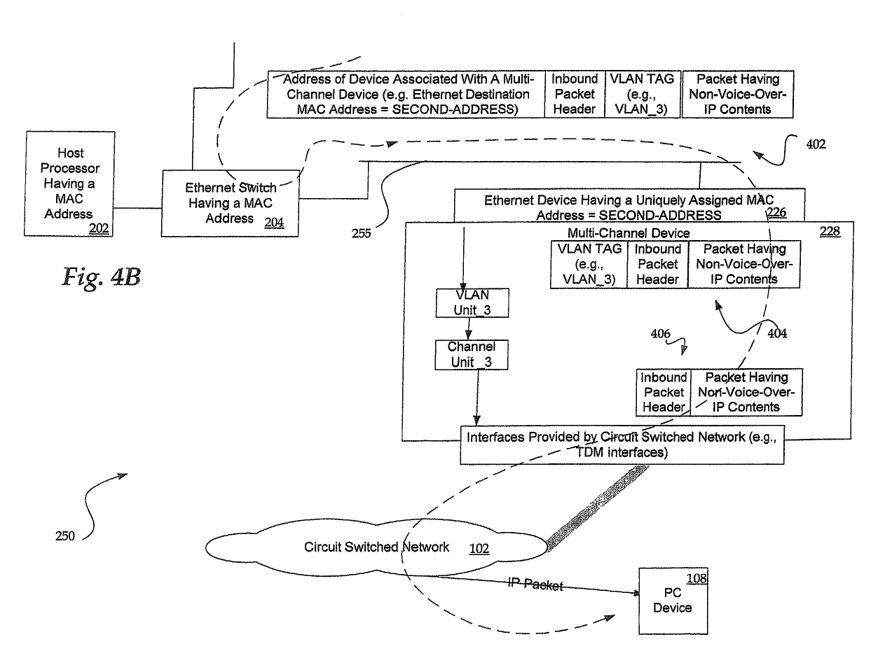

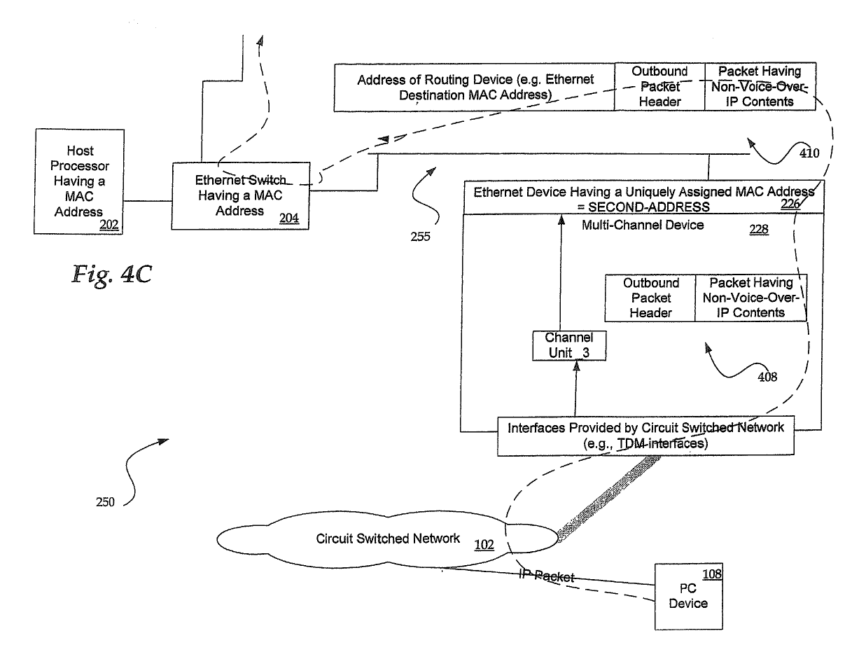

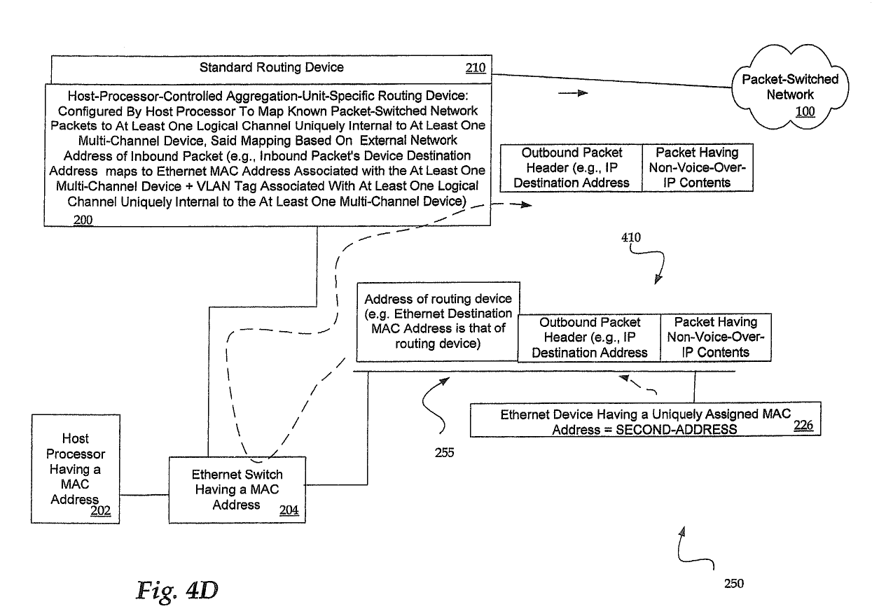

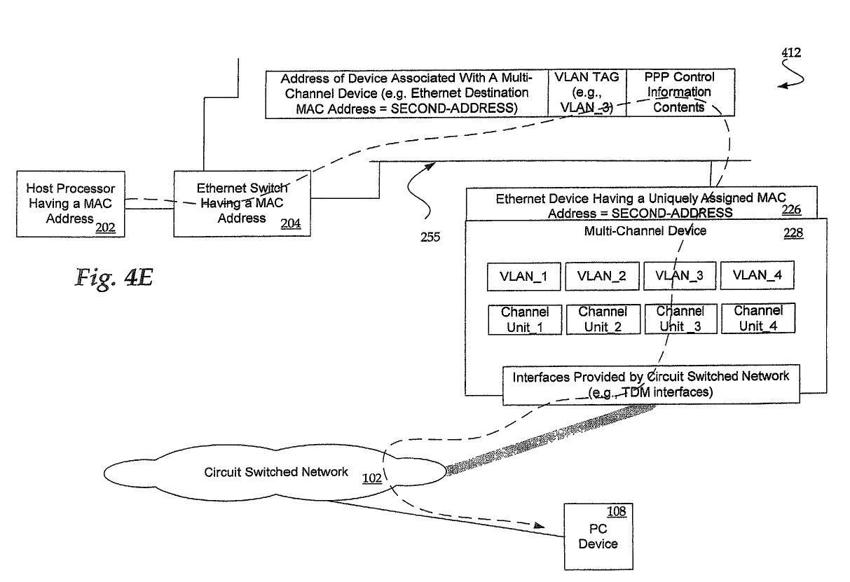

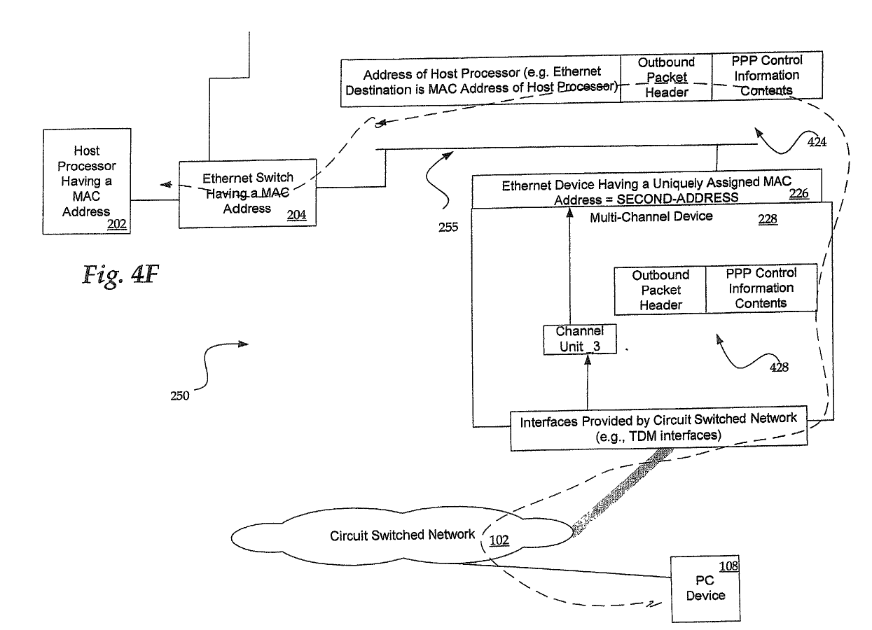

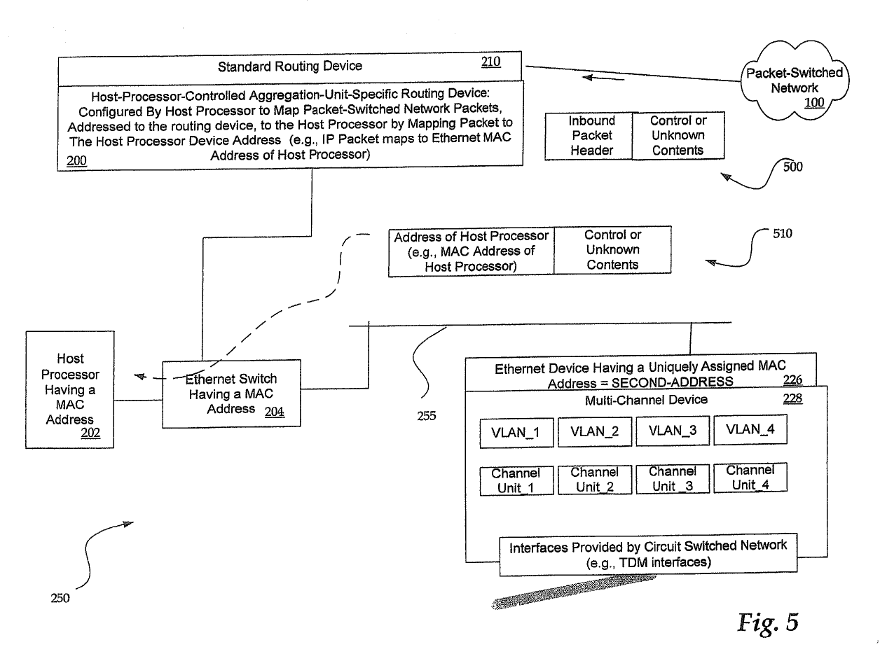

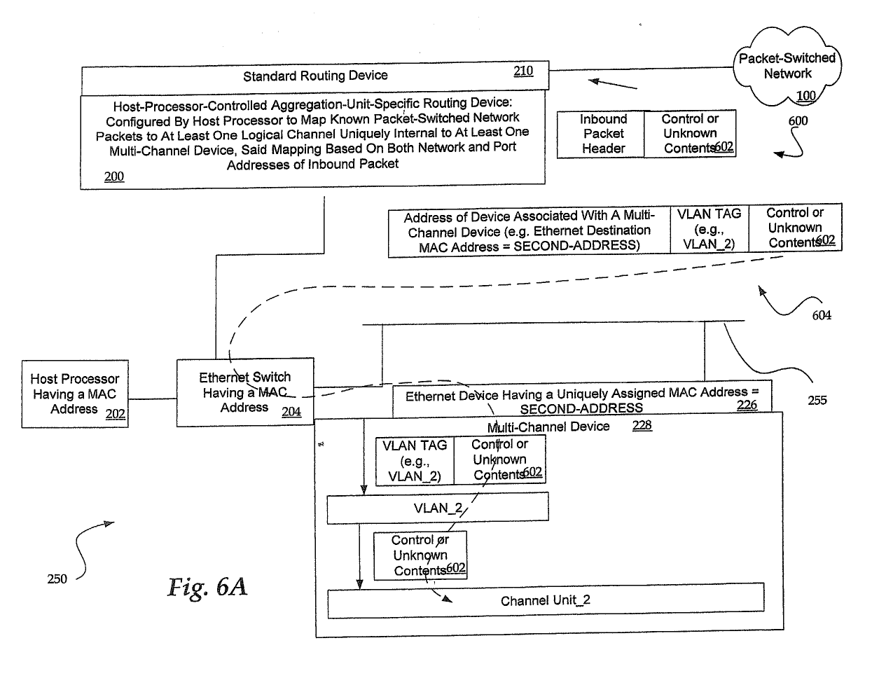

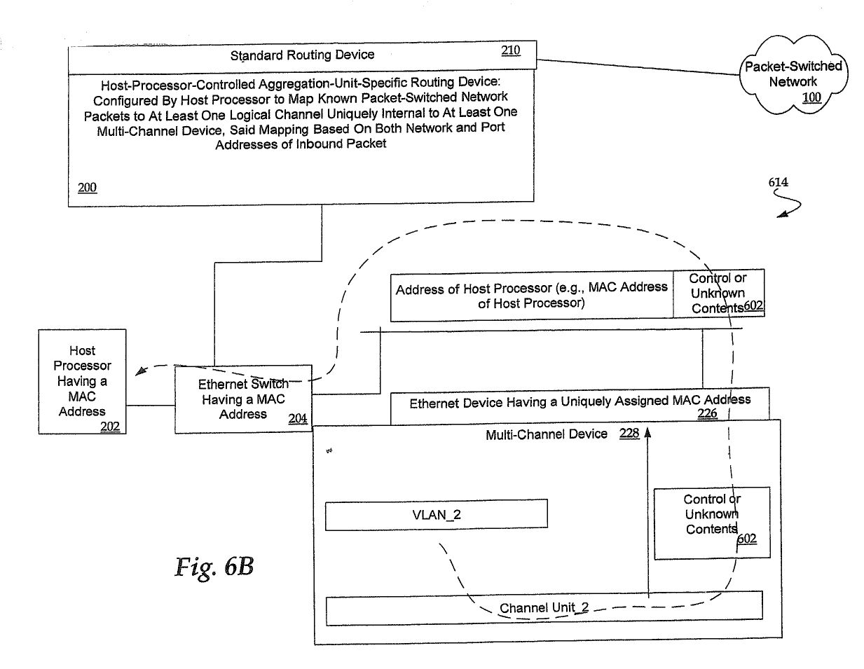

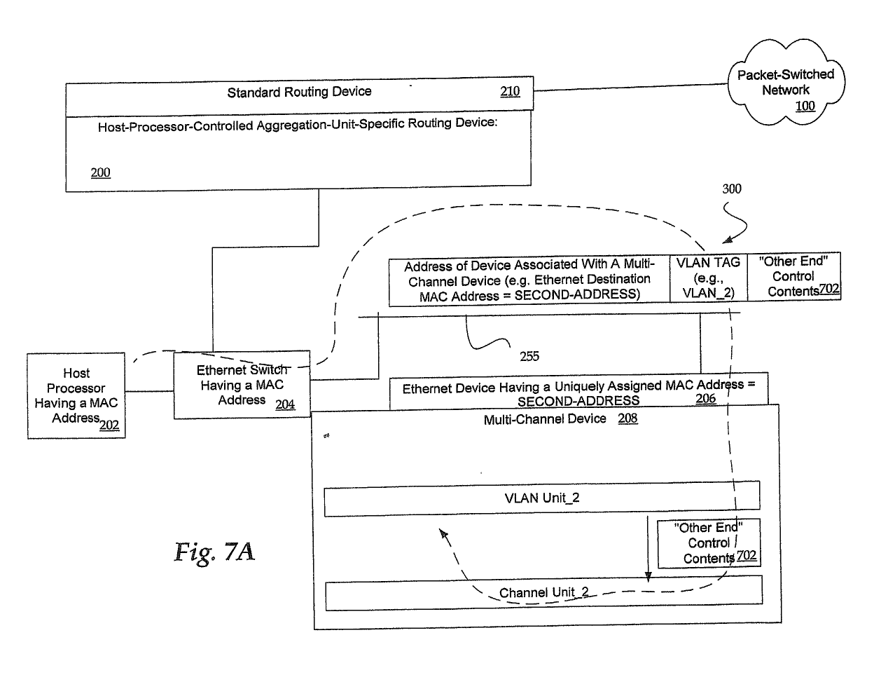

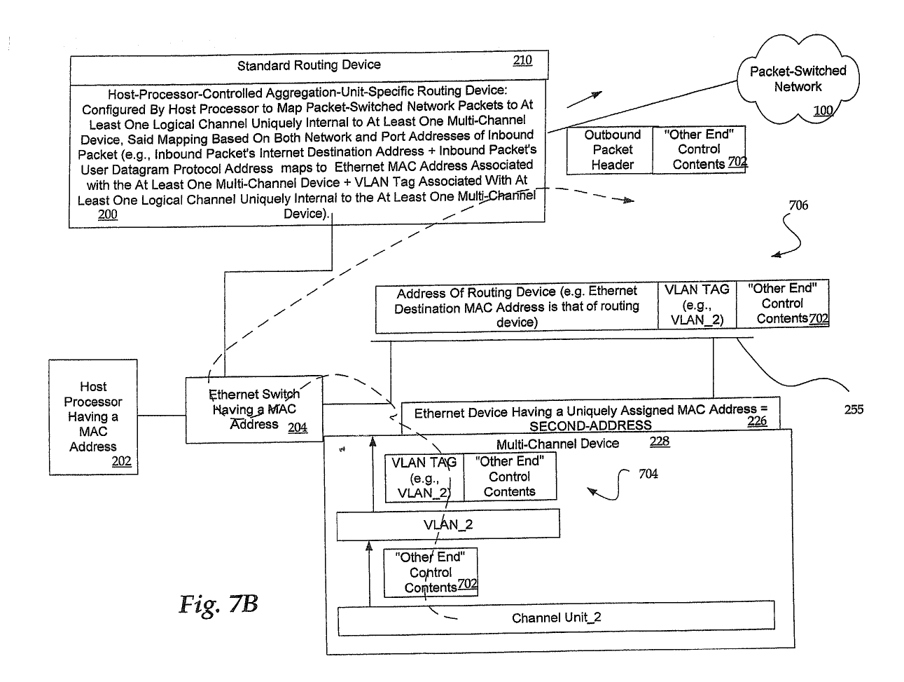

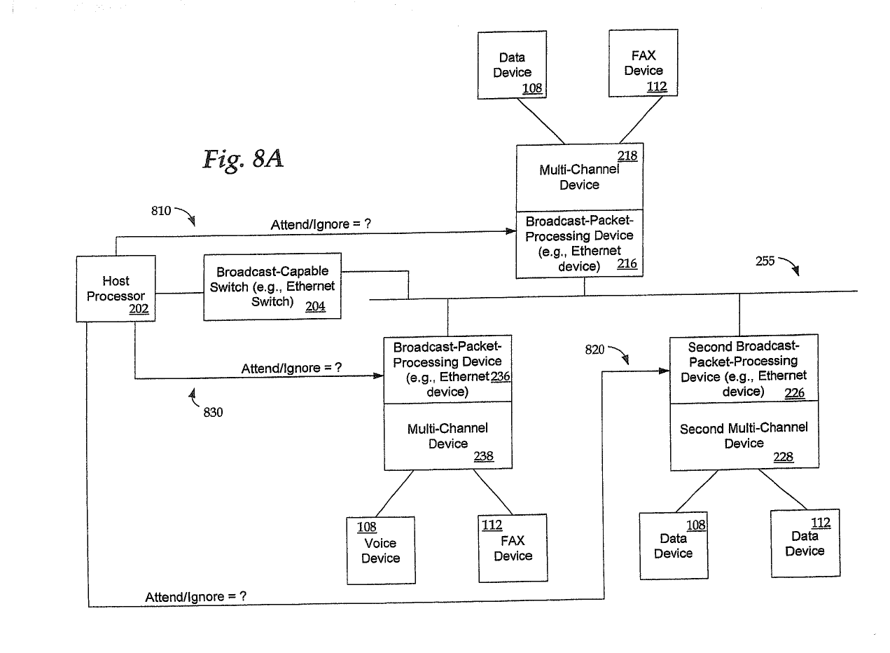

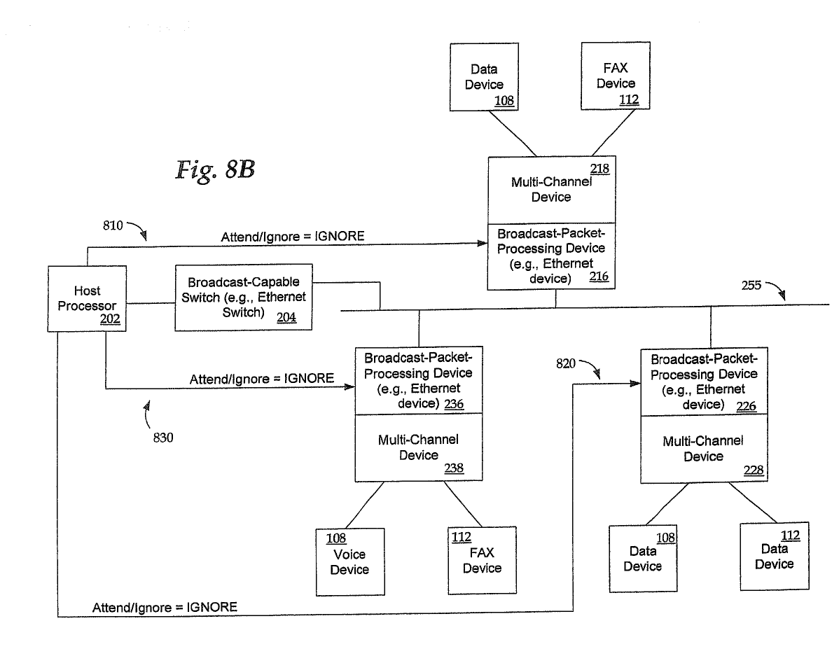

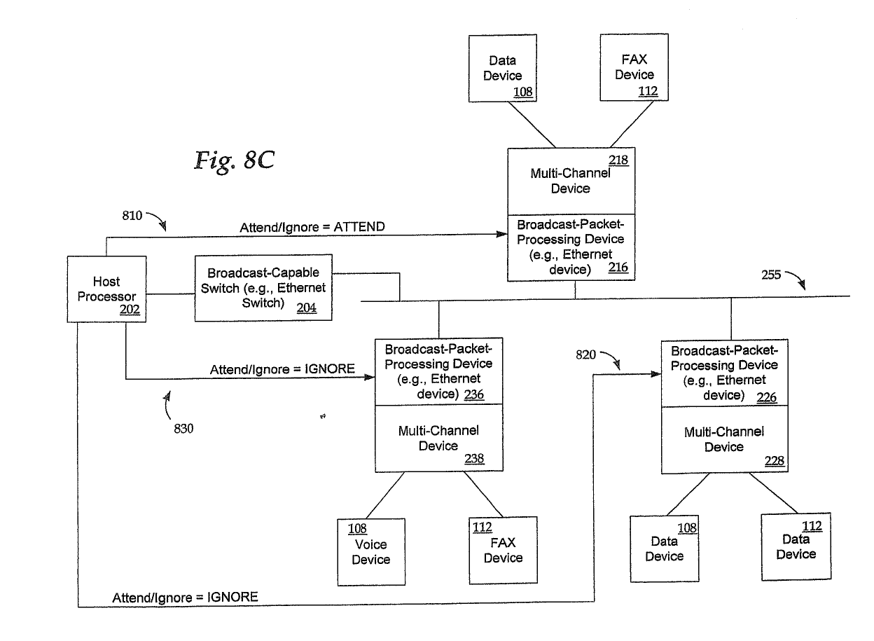

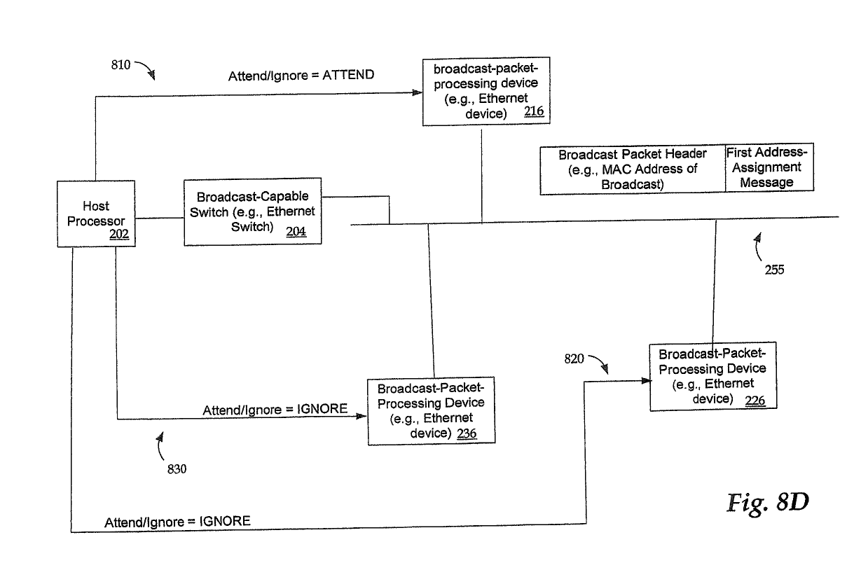

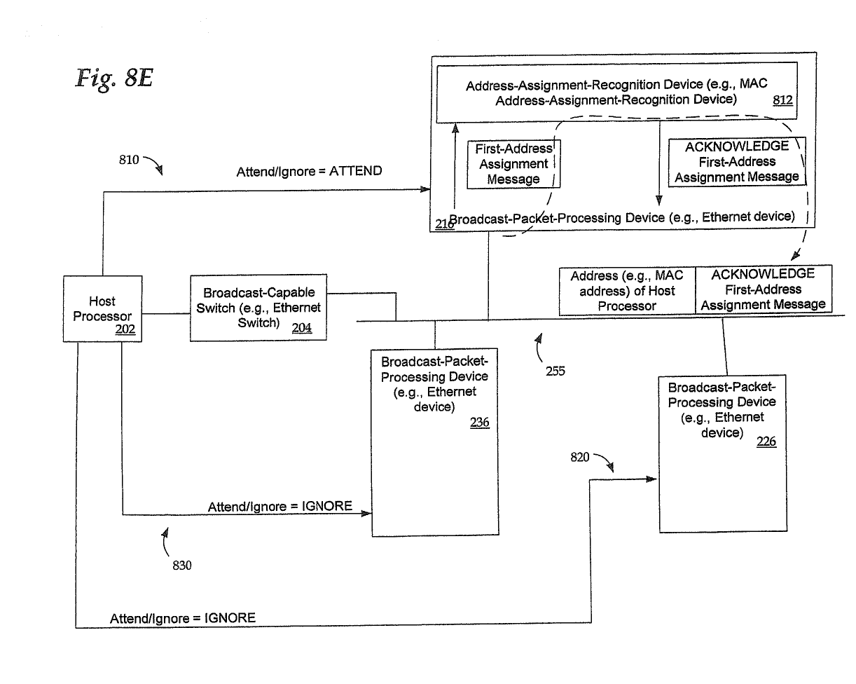

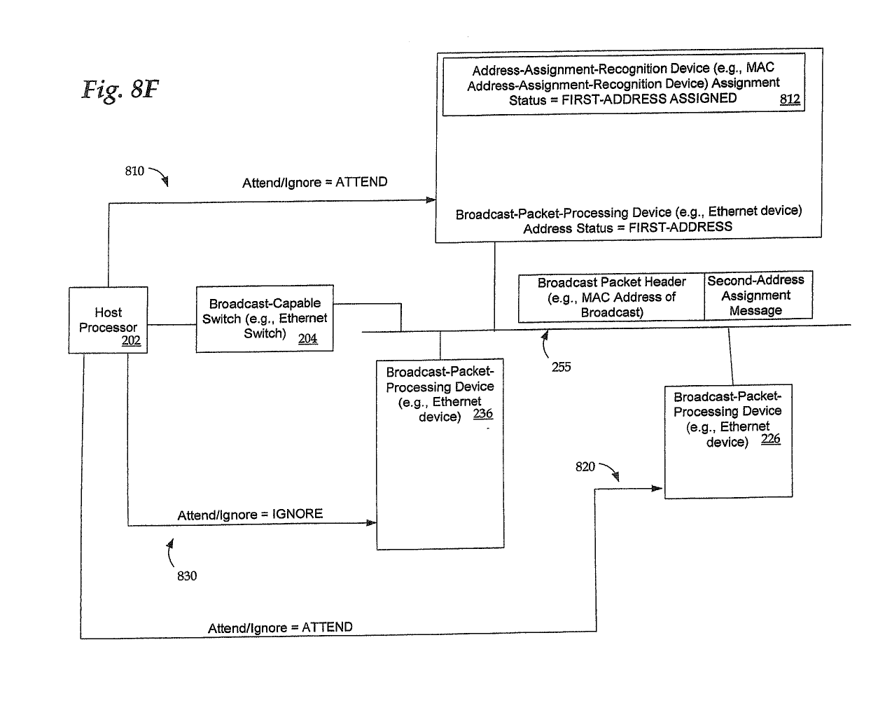

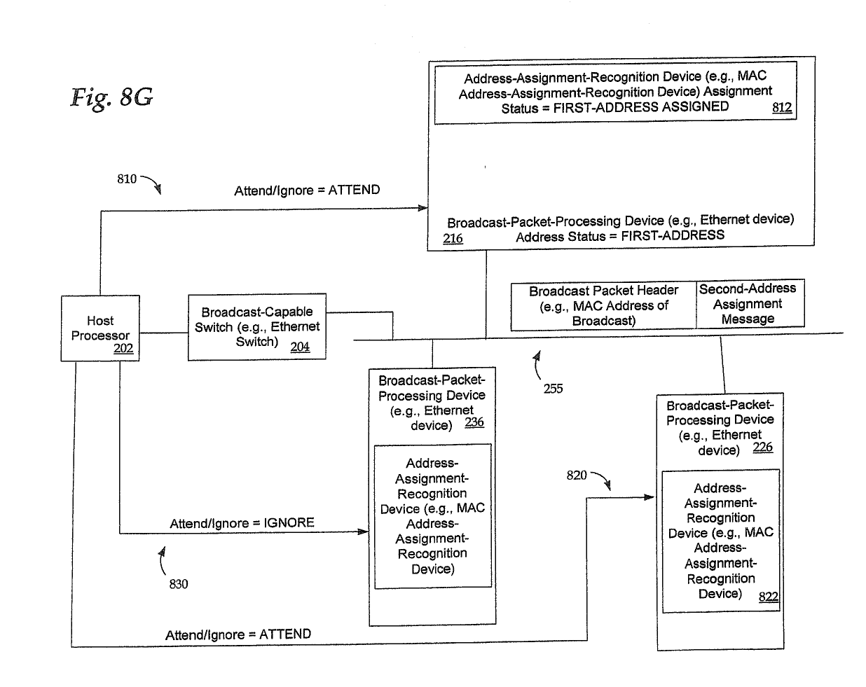

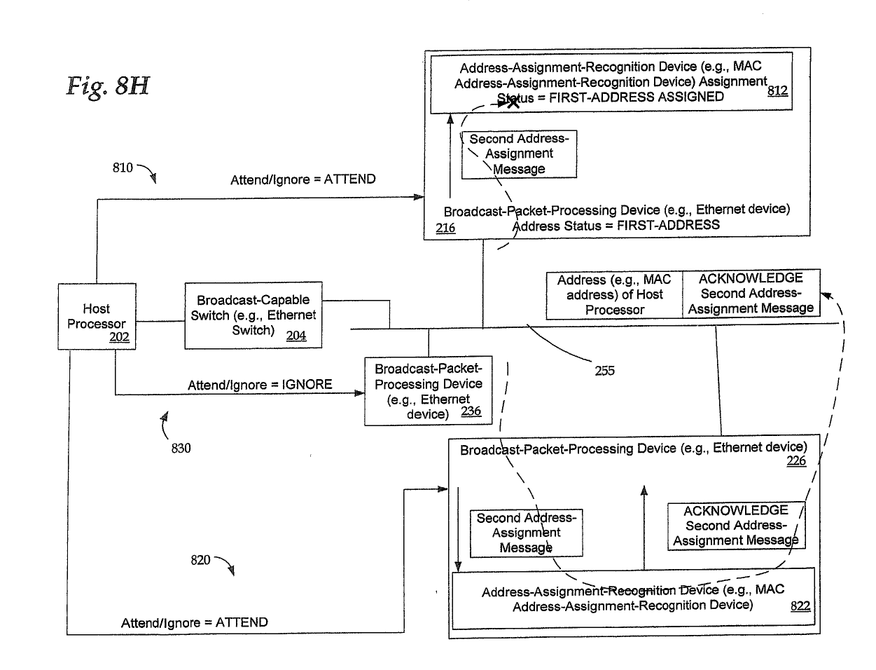

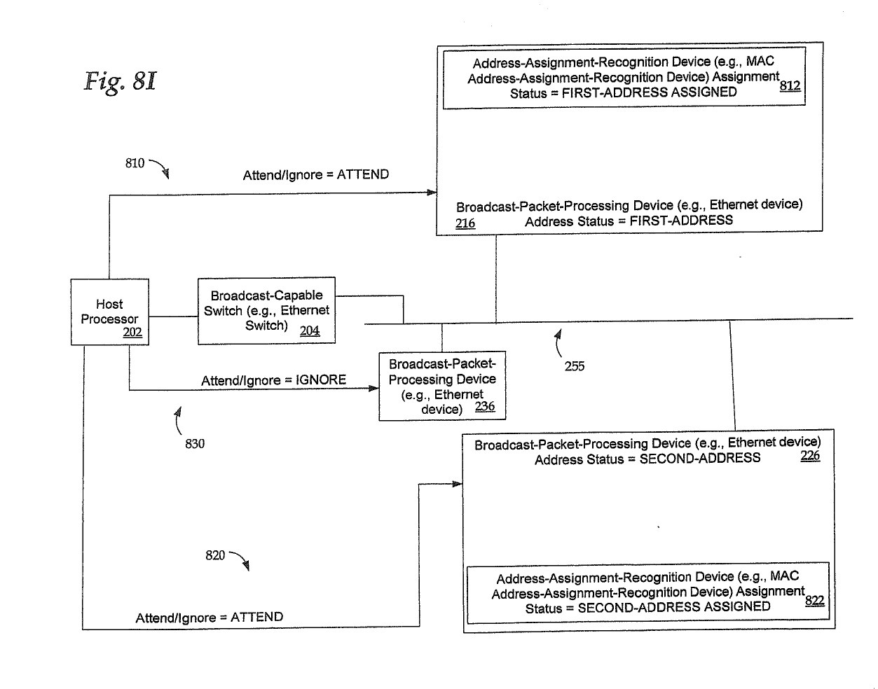

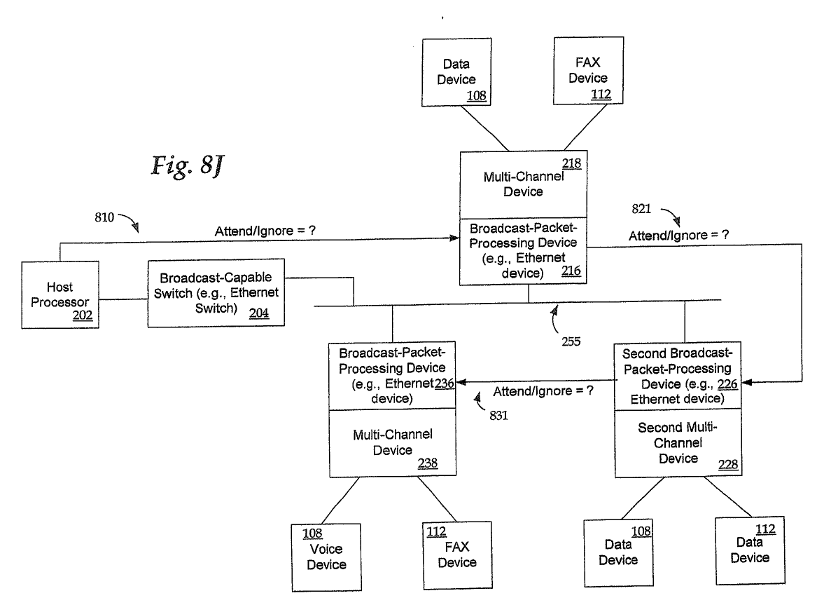

Referring now to FIG. 8A, shown is host processor 202 operably coupled (e.g., via a coaxial cable) with a broadcast-capable switch 204 (e.g., an Ethernet bridge, switch, or hub). Depicted are three broadcast-packet-processing devices (e.g., Ethernet devices) 216, 226, 236 operably coupled via a shared medium 255 (e.g., an Ethernet bus, which those having ordinary skill in the art will recognize may consist of either or both a shared medium and a non-shared medium) with the broadcast-capable switch 204. Illustrated are that all three broadcast-packet-processing devices 216, 226, 236 are respectively operably coupled with the host processor via attend-ignore lines 810, 820, 830.

With reference now to now to FIG. 8B, depicted is that the host processor 202 has directed the broadcast-packet-processing devices 216, 226, 236 to enter an ignore-initial-address-assignment mode via placing “ignore” values on all attend-ignore lines 810, 820, 830.

Referring now to now to FIG. 8C, illustrated is that the host processor 202 has directed a broadcast-packet-processing device 216 to enter a process-initial-address-assignment mode via placing an “attend” value on that first broadcast-packet-processing device's 216 attend-ignore line 810.

With reference now to now to FIG. 8D, shown is that the host processor 202 has transmitted a broadcast packet containing payload having a first address-assignment message (e.g., a message that an Ethernet device is to be assigned a MAC address), which the broadcast-capable switch 204 has routed onto shared medium 255.

Referring now to now to FIG. 8E, depicted is that the broadcast-packet-processing device 216 having an “attend” value on its attend-ignore line 810 processes the broadcast packet and passes the first-address assignment message to its address-assignment-recognition device 812. Upon receipt of the first-address assignment message, the internal address-assignment-recognition device 812 recognizes that its associated broadcast-packet processing device 216 does not yet have an assigned address. Accordingly, shown is that internal address-assignment-recognition device 812 accepts the first address assignment message, assigns “first address” to its broadcast-packet processing device 216, and thereafter sends an acknowledgment of the first-address assignment message to the host processor 202 to indicate that the “first-address assignment” has been completed.

With reference now to now to FIG. 8F, illustrated is that the host processor 202 has directed a second broadcast-packet-processing devices 226 to enter a process-initial-address-assignment mode via placing an “attend” value on that second broadcast-packet-processing device's 226 attend-ignore line 820. Further shown is that the address-assignment-recognition device (e.g., MAC address-assignment-recognition device) 812 has an assignment status equal to “first-address assigned”, and that its associated broadcast-packet-processing device (e.g., Ethernet device) 216 has an address status equal to first-address as a result of the operations described in relation to FIG. 8E.

Referring now to now to FIG. 8G, shown is that the host processor 202 has transmitted a broadcast packet containing payload having a second address-assignment message, which the broadcast-capable switch 204 has routed onto shared medium 255.

Referring now to now to FIG. 8H, depicted is that the first and second broadcast-packet-processing devices 216, 226 respectively having an “attend” value on their attend-ignore lines 810, 820, respectively process the broadcast packet and pass the second address-assignment message to their respective internal address-assignment-recognition devices 812, 822. Upon receipt of the second address-assignment message, the internal address-assignment-recognition device 812 associated with the first broadcast-packet-processing device 216 recognizes that its associated broadcast-packet processing device 216 has already been assigned an address (via its Assignment Status equal to “first-address assigned”), and hence ignores the second address-assignment message. Further shown is that, upon receipt of the second address-assignment message, the internal address-assignment-recognition device 822 associated with the second broadcast-packet-processing device 226 which does not yet have an assigned address recognizes that its associated broadcast-packet processing device 226 has not already been assigned an address, and hence shown is that the internal address-assignment-recognition device 822 associated with the second broadcast-packet-processing device assigns the second packet-processing device 226 the second address indicated by second-address assignment message, and thereafter sends an acknowledgment to the host processor 202 that the second address assignment has been accepted.

With reference now to now to FIG. 8I, shown is that the address-assignment-recognition device (e.g., MAC address-assignment-recognition device) 822 has an assignment status equal to “second-address assigned”, and that its associated broadcast-packet-processing device (e.g., Ethernet device) 226 has an address status equal to second-address as a result of the operations described in relation to FIG. 8E.

FIGS. 8B-8I have described the assignment of address to two of the three broadcast-packet-processing devices 206. In one implementation, the remaining (third) broadcast-packet-processing device 206 is thereafter assigned its address via a straightforward extension of the procedure illustrated in FIGS. 8G-8I, where such extension is well within the ambit of one having ordinary skill in the art. Furthermore, although only the assignment of three broadcast-packet-processing device addresses have been described herein, those having ordinarily skill in the art will recognize that the scheme described herein can be extended to many (e.g., hundreds) of broadcast-packet-processing devices via reasonable experimentation well within the ambit of one having ordinary skill in the art.

With reference now to FIG. 8J, shown is an alternate embodiment of the system shown in FIG. 8A. The system shown in FIG. 8J is substantially similar to that shown in 8A, with the exception that the host processor 202 is shown to be operably coupled with only one of the broadcast-packet-processing devices 216 via its attend-ignore line 810. Depicted is that the remaining two broadcast-packet-processing devices 226, 236 are respectively operably coupled with each other via their respective attend-ignore lines 821, 831.

In operation, assigning addresses to the packet-processing-devices via the alternate system shown in FIG. 8J is done in a fashion based upon a straightforward extension of the process described in relation to FIG. 8A, except that “daisy-chaining” is used to sequentially control the attend-ignore lines 810, 821, 831. For example, the host processor 202 causes an attend value to appear on the attend-ignore line 810 of the first packet-processing-device 216, and then causes a first address to be assigned to the first packet-processing-device 216. Thereafter, subsequent to address assignment, the first packet processing device 216 causes an attend value to appear on the second attend-ignore line 821 which feeds into a second packet-processing-device, and then causes a second address to be assigned to the second packet-processing-device 226. Thereafter, subsequent to address assignment, the second packet processing device 226 causes an attend value to appear on the third attend-ignore line 831 which feeds into the third packet-processing-device 236, and then causes a third address to be assigned to the third packet-processing-device 236. In the foregoing described process, the address assignments are done in a substantially similar fashion to that described in relation to FIGS. 8B-8I, except for the fact that daisy chaining, rather than direct control by the host processor 202, is used to control the attend-ignore lines of the second and third packet processing devices 206. In addition to the foregoing, it should be noted that in some implementations, the attend values remain on the attend-ignore lines after respective address assignments, while in other implementations, ignore values are placed on the attend-ignore lines after respective address assignments.

The preceding discussions have described transmitting broadcast packets containing payload having a specific-address assignment messages. In one implementation, such transmission is characterized by the host processor 202 repetitively transmitting each broadcast packet containing payload having a specific-address assignment messages until an acknowledgement from the specific address has been received by the host processor 202. For example, returning to the example FIG. 8A-8I, in one implementation the host processor 202 will intermittently retransmit the broadcast packet having the first-address assignment message until the host processor 202 receives an acknowledgement that the first address-assignment has been achieved. In a related implementation, insofar as it is possible that the host processor 202 did not receive the previously-transmitted acknowledgement that the first-address assignment has been achieved, accordingly if the packet-processing-device 216 shown in FIG. 8I subsequently receives a duplicate first-address assignment message, its internal address-assignment-recognition device 812 merely retransmits an acknowledgment that the address assignment has been done, such as was illustrated in FIG. 8E.

At this point, the broadcast-packet-processing devices have been assigned their addresses (e.g., Ethernet devices have been assigned their unique MAC addresses). It is now desirable to activate the multi-channel devices 208 uniquely connected with the addressed broadcast-packet-processing devices. In one implementation, this is achieved via booting the multi-channel devices.

II. Booting Multi-Channel Devices

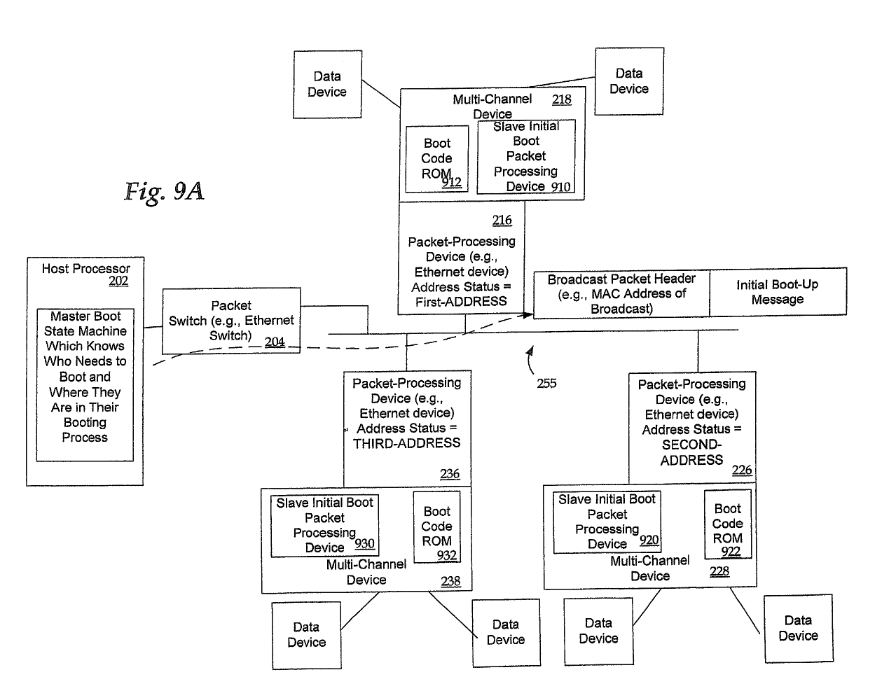

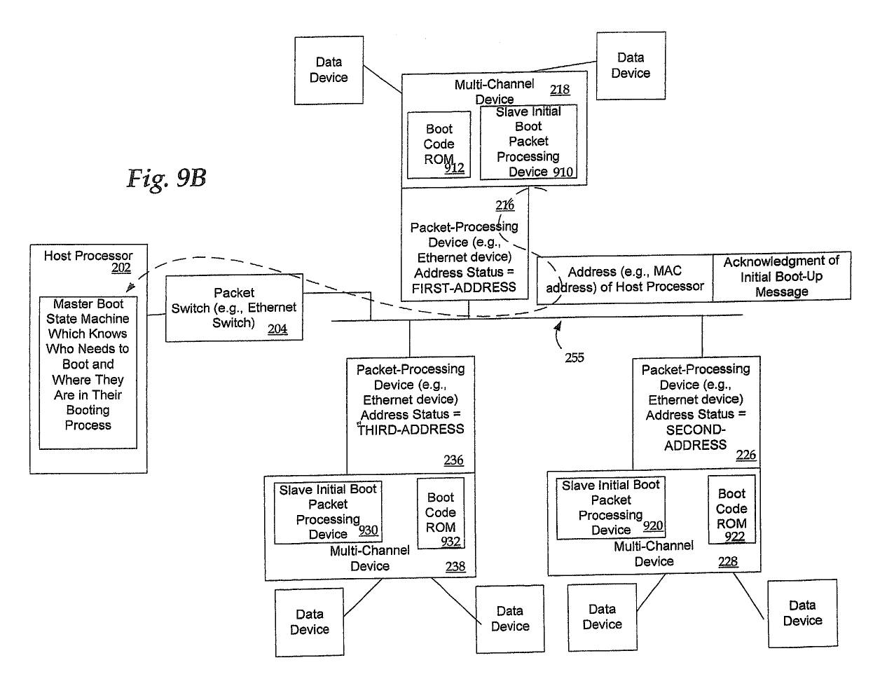

Referring now to FIG. 9A, shown are multi-channel devices 218, 228, 238 in the context of a system wherein packet-processing devices 216, 226, 236 have pre-assigned addresses. In one implementation, packet-processing devices 216, 226, 236 have been pre-assigned their addresses via one or more of the addressing schemes described in Section I (“assigning addresses to packet-network devices”), above. However, in other implementations the packet-processing devices 216, 226, 236 have had their addresses assigned in other ways (e.g., via ROM, as is conventionally done).

Continuing to refer to FIG. 9A, depicted is that each multi-channel device 218, 228, 238 respectively has an internal slaved initial boot packet processing device 910, 920, 930 and boot-control code ROM 912, 922, 932. In one implementation, the multi-channel devices 218, 228, 238 are substantially indistinguishable from each other, while in other implementations individual multi-channel devices differ.

FIG. 9A illustrates the host processor 202 initiating transmission of at least one packet containing payload having an initial boot-up message, which packet switch 204 transmits onto shared medium 255. In one implementation, a single broadcast packet containing the initial boot-up message is transmitted. In another implementation, packets individually addressed to the packet-processing devices, each such packet containing the initial boot-up message, are transmitted.

Upon receipt of the packet containing the initial boot up message, each multi-channel device 218, 228, 238 delivers the boot-up message to its respective slaved initial boot packet processing device 910, 920, 930. Thereafter, each slaved initial boot packet processing device 910, 920, 930 respectively boots from its respective boot-control code ROM 912, 922, 932.

Referring now to FIG. 9B, shown is that in one implementation, when multi-channel channel device 218 having slaved initial boot packet processing device 910 has respectively booted, slaved initial boot packet processing device 910 transmits a packet having a destination address of the host processor 202 and a source address of the packet-processing device 216. Insofar as that the host processor 202 has knowledge of all active packet-processing devices 216, 226, 236 on the shared medium 255 (either because the addresses are pre-assigned or because the host processor has assigned the addresses as in Section I, above), the host processor 202 can treat those known addresses as the “set” of addresses. Accordingly, when the host processor 204 receives an acknowledgment that a multi-channel device has successfully booted, the host processor 202 can add the source address of the packet in which the acknowledgment was contained to a set of “booted-up” addresses (if the source addresses are not already represented in the set of received addresses). Thereafter, the host processor can compare the set of received “booted-up” addresses against the set of the known earlier-assigned packet-processing device addresses (e.g., first-address, second-address, and third-address in FIGS. 9A, 9B), and can continue retransmitting the booted-up message packets until the set of received booted-up addresses matches the set of known addresses.

As has been described, in some implementations the host processor 202 retransmits a boot-up message if the host processor 202 has not received acknowledgement from all multi-channel devices that an earlier-sent boot-up message has been processed. The possibility exists that the device has been booted up, but that for some reason the acknowledgment has been lost. Accordingly, in one implementation when a slaved initial boot packet processing device receives a boot-up message, but the multi-function device having the slaved initial boot packet processing device which received the boot-up message has already booted, the slaved initial boot packet processing device determines that boot-control code has previously been executed, and hence does not reboot. However, the slaved initial boot packet processing device does send an acknowledgment of the duplicate boot-up message.

Those having ordinary skill in the art will appreciate that while the retransmission and acknowledgement schemes described above have only been discussed in the context of booting multi-channel devices, the retransmission and acknowledgement schemes can be applied to virtually any transmissions, related to the low-processor-load aggregation device 250, which need to be protected from error or loss. In light of the teachings herein, the retransmission and acknowledgement schemes described can be applied to the foregoing-described other transmissions via a minor amount of experimentation well within the ambit of one having ordinary skill in the art.

III. Low-Processor-Load Aggregation

a. Low-Processor-Load Aggregation Unit Expected to Provide Some Level of Voice Data Processing

With reference now to FIGS. 3A-3E, shown are a series of high-level block diagrams depicting an implementation of a method in the context of a partial view of the-low-processor-load aggregation device 250, where the low-processor-load aggregation device 250 is expected to provide some level of voice data processing. Referring now to FIG. 3A, shown is standard routing device 210 receiving an inbound packet 300 having payload containing voice (e.g., voice over IP) contents of a type which the low-processor-load aggregation device 210 is expected to process (rather than just pass on). Although the discussion herein describes the payload as containing voice (e.g., voice over IP) contents of a type which the low-processor-load aggregation device 210 is expected to process (rather than just pass on), it will be appreciated by those having ordinary skill in the art that the voice contents of a type which the low-processor-load aggregation device 210 is expected to process (rather than just pass on) are representative of other types of contents which the low-processor-load aggregation device 210 is expected to process (rather than just pass on). Examples of such other types of contents which the low-processor-load aggregation device 210 is expected to process are Fax over IP (e.g., International Telecommunications Union (ITU) T.38) contents, Modem Over IP (e.g., Telecommunications Industry Association (TIA) TR 30.1) contents, and other contents recognized as analogous to the foregoing by those having ordinary skill in the art. Those having ordinary skill in the art will appreciate that the examples herein can be extended to such other contents which the low-processor-load aggregation device 210 is expected to process (rather than just pass on), via a reasonable amount of experimentation well within the ambit of one having ordinary skill in the art.

Continuing to refer to FIG. 3A, depicted is that standard routing device 210 examines the destination address in the header of the inbound packet 300, and determines from its (standard routing device's 210) internal routing table that the destination address of the inbound packet 300 header is associated with the port(s) of the standard routing device 210 that feed into the host-processor-controlled aggregation-unit-specific routing device 200, and consequently routes the inbound packet “downward” to the host-processor-controlled aggregation-unit-specific routing device 200.

The host-processor-controlled aggregation-unit-specific routing device 200 has been earlier configured by the host processor 202 to recognize that the address of the received inbound packet 300 is an address that is potentially associated with a channel involving the voice device 112 (in one implementation, this potential association is recognized via inbound packet 300 being addressed to the one or more packet network addresses associated with the host-processor-controlled aggregation-unit-specific routing device 200), where the voice device 112 is expecting the low-processor-load aggregation device 250 to provide processing of voice data (e.g., Pulse Code Modulated (PCM) data). Accordingly, the host-processor-controlled aggregation-unit-specific routing device 200 looks relatively deeply into the received inbound packet 300 to see if the port identification of the packet (e.g. inbound packet's 300 User Datagram Protocol (UDP) Port if the packet switched network 100 is using IP) is one that the host processor 202 has earlier established is a port identifier that is potentially associated with expected voice processing.

If, upon looking into the received inbound packet 300, the host-processor-controlled aggregation-unit-specific routing device 200 determines that the port identification of the packet is one that the host processor 202 has earlier indicated as a port identifier that is potentially associated with expected voice processing, the host-processor-controlled aggregation-unit-specific routing device 200 maps the known inbound packet to at least one logical channel uniquely internal to at least one multi-channel device, said mapping based on both the network and port addresses of the inbound packet 300; for example, in the case where the packet switched network 100 is using Internet Protocol (IP), the inbound packet's internet destination address and the inbound packet's user datagram protocol port number will be respectively mapped to an Ethernet MAC address uniquely associated with the multi-channel device 228 and a (Virtual Local Area Network) VLAN tag associated with at least one logical channel uniquely internal to the multi-channel device 228 (in some implementations the association is one-to-one), where the at least one logical channel is one end of a logical channel established with voice device 112 (e.g., the logical channel maintained by channel unit_2 of multi-channel device 228). Those having ordinary skill in the art will appreciate that the multi-channel device 228 is described as “associated with” the MAC address in that the association arises, in one implementation, from the fact that each of the multi-channel devices 218 (FIG. 2), 228, 238 (FIG. 2) is uniquely connected to a corresponding Ethernet device having a uniquely assigned MAC address.

Continuing to refer to FIG. 3A, shown is that host-processor-controlled aggregation-unit-specific routing device 200 strips the packet network header from the inbound packet 300, and creates an Ethernet frame 302 having a destination MAC address associated with the multi-channel device 228, and further having, internal to the Ethernet frame, a VLAN tag associated with a “VLAN” (e.g. VLAN_2) which is associated with a logical channel (e.g., that maintained by channel unit_2) internal to the multi-channel device 228. Those having ordinary skill in the art will appreciate that although VLAN tags and associated VLANs are described herein for sake of illustration, those having ordinary skill in the art can adapt the teachings herein to other tags via a minimum amount of experimentation well within the ambit of one having ordinary skill in the art. However, the inventors note that in some Ethernet implementations VLAN tags provide significant benefits in that both legacy and new Ethernet switches tend not to “see” VLAN identifiers, and hence in one implementation VLAN tags have been found to a high degree of accuracy and ease of use when utilized with the teaching provided herein. Depicted is that the Ethernet frame 302 is sent onto Ethernet bus 255 by Ethernet switch 204.

With reference now to FIG. 3B, depicted is that upon receipt of the Ethernet frame 302, the device having the MAC address of the Ethernet frame 302 strips the Ethernet header and hands the residual VLAN-tagged packet 304 into multi-channel device 228. Multi-channel device 228 delivers VLAN-tagged packet 304 to the VLAN unit (e.g., VLAN Unit_2 as shown in FIG. 3B) identified by the VLAN tag of the VLAN-tagged packet 304 (in one implementation, this association between VLAN and channel unit is recognized on the basis of control information earlier-sent to multi-channel device 228 by host processor 202). Illustrated is that VLAN Unit_2 removes the VLAN tag from the VLAN-tagged packet 304 and delivers the remaining voice-over-IP data to its (VLAN Unit_2's) associated channel unit (e.g., channel unit_2, as shown in FIG. 3B). As shown, the associated channel unit converts the voice-over-IP data into its PCM representation, and then sends the PCM data to the voice device 112.

FIGS. 3A-3B demonstrated an inbound voice packet transiting the low-processor-load aggregation device 250. FIGS. 3C-3D will demonstrate an outbound voice packet transiting the low-processor-load aggregation device 250

Referring now to FIG. 3 C, depicted is that upon receipt of the PCM data from the voice device 112, the channel unit (e.g., channel unit_2) converts the PCM data into an outbound voice-over-IP packet 308 appropriately addressed to and bound for the external packet-switched network 100 (FIG. 2), and thereafter hands the voice-over-IP packet 308 to the Ethernet device 226, which encapsulates the voice-over-IP packet 308 into an Ethernet frame 310 which has as its destination address the MAC address of the host-processor-controlled aggregation-unit-specific routing device 200. Thereafter, Ethernet device 226 transmits the Ethernet frame 310 over Ethernet bus 255.

With reference now to FIG. 3D, illustrated is that Ethernet switch 204 switches Ethernet frame 310 to host-processor-controlled aggregation-unit-specific routing device 200. Thereafter, shown is that the host-processor-controlled aggregation-unit-specific routing device 200 removes the Ethernet headers from the Ethernet frame 310, and thereafter transmits the outbound voice-over-IP packet 308 out into the packet-switched network 100.

FIGS. 3A-3D illustrated a situation representative of those instances in which the low-host-processor-load aggregation device 250 is expected to provide voice processing for a network station device. However, in most instances, the low-host-processor-load aggregation device 250 will not be expected to provide such processing. FIGS. 4A-4F address various implementations addressing the more common case.

b. Low-Processor-Load Aggregation Unit Expected to Function as Passive Conduit for Data

Referring now to FIGS. 4A-4F, shown are a series of high-level block diagrams depicting an implementation of a method in the context of the low-processor-load aggregation device 250 where a network station is not expecting that the-low-processor-load aggregation device 250 will provide voice processing. Referring now to FIG. 4A, shown is the standard routing device 210 receiving an inbound-packet 400, where the inbound-packet 400 has payload which low-processor-load aggregation device 250 is not expected to process. Standard routing device 210 examines the destination address of the inbound-packet header, determines from its routing table that the destination address is associated with the attached aggregation device, and consequently routes the inbound packet “downward” to the host-processor-controlled aggregation-unit-specific routing device 200.

The host-processor-controlled aggregation-unit-specific routing device 200 has been earlier configured by the host processor 202 (FIG. 2) to recognize that the address of the received inbound packet 400 is associated with a channel of a particular multi-channel device which is associated with the MAC address. Accordingly, depicted is that host-processor-controlled aggregation-unit-specific routing device 200 maps the known inbound packet to at least one logical channel uniquely internal to at least one multi-channel device, said mapping based on the network address of the inbound packet 400; for example, in the case where the packet switched network 100 is using Internet Protocol (IP), the inbound packet's internet destination address will be mapped to an Ethernet MAC address uniquely associated with the multi-channel device 228 and a VLAN tag associated with at least one logical channel uniquely internal to the multi-channel device 228, where the at least one logical channel is one end of a logical channel established with data device 108 (e.g., the logical channel maintained by channel unit_3 of multi-channel device 228). Those having ordinary skill in the art will appreciate that the multi-channel device is described as “associated with” the MAC address in that the association arises, in one implementation, from the fact that each of the multi-channel devices 218 (FIG. 2), 228, 238 (FIG. 2) is uniquely connected to an Ethernet device having a uniquely assigned MAC address.

Continuing to refer to FIG. 4A, shown is that host-processor-controlled aggregation-unit-specific routing device 200 encapsulates the entire inbound packet 400 (i.e., the entirety of the inbound packet 400, including both the payload and its associated inbound packet header), and creates an Ethernet frame 402 having a MAC destination address of Ethernet device 226 associated with multi-channel device 228, and further having, internal to the Ethernet frame, a VLAN tag associated with a “VLAN” (e.g., VLAN_3) which is associated with a logical channel (e.g., the logical channel maintained by channel unit_3) maintained internal to the multi-channel device 228. Those having ordinary skill in the art will appreciate that although VLAN tags and associated VLANs are described herein for sake of illustration, those having ordinary skill in the art can adapt the teachings herein to other tags via a minimum amount of experimentation well within the ambit of one having ordinary skill in the art. However, the inventors note that in some Ethernet implementations VLAN tags provide significant benefits in that both legacy and new Ethernet switches tend not to “see” VLAN identifiers, and hence in one implementation VLAN tags have been found to a high degree of accuracy and ease of use when utilized with the teaching provided herein. Depicted is that the Ethernet frame 402 is sent onto Ethernet bus 255 by Ethernet switch 204.

With reference now to FIG. 4B, depicted is that upon receipt of the Ethernet frame 402, the device having the MAC address of the Ethernet frame 402 strips the Ethernet header and hands the residual VLAN-tagged packet 404 into multi-channel device 228. Multi-channel device 228 delivers VLAN-tagged packet 404 to the VLAN unit (e.g., VLAN Unit_3 as shown in FIG. 4B) identified by the VLAN tag of the VLAN-tagged packet 404. Illustrated is that VLAN Unit_3 removes the VLAN tag from the VLAN-tagged packet 404 and delivers the inbound packet 400, including both the payload and its associated inbound packet header, to its associated channel unit (e.g., channel unit_3 as shown in FIG. 4B). As shown, the associated channel unit sends the inbound packet 400 to the PC device 108.

FIGS. 4A-4B demonstrated an inbound non-voice packet transiting the low-processor-load aggregation device 250. FIGS. 4C-4D will demonstrate an outbound non-voice packet transiting the low-processor-load aggregation device 250.

Referring now to FIG. 4C, depicted is that upon receipt of an outbound packet 408 appropriately addressed to and bound for the external packet-switched network 100 (FIG. 2), multi-channel device 228 hands the outbound packet 408 to the Ethernet device 226, which encapsulates the outbound packet 408 into an Ethernet frame 410 which has as its destination address the MAC address of the host-processor-controlled aggregation-unit-specific routing device 200. Thereafter, Ethernet device 226 transmits the Ethernet frame 410 over Ethernet bus 255.

With reference now to FIG. 4D, illustrated is that Ethernet switch 204 switches Ethernet frame 410 to host-processor-controlled aggregation-unit-specific routing device 200. Thereafter, shown is that the host-processor-controlled aggregation-unit-specific routing device 200 removes the Ethernet headers from the Ethernet frame 410, and thereafter transmits the residual outbound packet 408 out into the packet-switched network 100.

FIGS. 3A-3D illustrated instances in which the low-processor-load aggregation device 250 is expected to provide processing of the contents of voice packets over an established channel. FIGS. 4A-4D illustrated instances in which the low-processor-load aggregation device 250 is only expected to forward packets and is not expected to process the contents of those forwarded packets. FIGS. 4E-4F, described following, illustrate instances in which the low-processor-load aggregation device 250 is expected to provide some control functions based upon specifically-identified control packets via an example based upon PPP (Point to Point Protocol) processing; the scheme in FIGS. 4E-4F is a hybrid of the schemes illustrated in FIGS. 3A-3D and 4A-4D.

c. Low-Processor-Load Aggregation Unit Expected to Provide Some Control Information Processing

In some instances, in addition to the low-processor-load aggregation unit providing data transfer such as has been discussed previously, a network station using the low-processor-load aggregation unit 250 will expect that the low-processor-load aggregation unit 250 will support a PPP link. By way of introduction, those having ordinary skill in the art will appreciate that PPP is typically used to provide data link control functions between a network station (e.g., the PC device 108) and the low-processor-load aggregation device 250. Accordingly, the PPP control information generally only needs to be exchanged between the PC device 108 and the low-processor-load aggregation device 250 (i.e., the PPP control information will typically only be exchanged between the low-processor-load aggregation device 250 and a network station (e.g., PC device 108) so that data link control is maintained).

Referring now to FIGS. 4E-4F, shown is the situation where the PC device 108 is expecting the low-processor-load aggregation device 250 to provide some control functions related to the NCP and LCP control aspects of the PPP protocol. As has been noted, the PPP control information generally need only be exchanged between the PC device 108 and the low-processor-load aggregation device 250 so that data link control is maintained.

Illustrated is that the host processor 202 creates PPP control information (e.g, LCP or NCP packets), appends a VLAN tag (e.g., VLAN_3 tag) to the PPP control information, and thereafter encapsulates the entire VLAN tag-PPP control information packet in an Ethernet frame 412 having as a destination MAC address that of the Ethernet device 226 associated with the multi-channel device 228. As shown, the Ethernet device 226 houses the channel unit (e.g., channel unit_3) associated with at least one logical channel uniquely internal to the at least one multi-channel device (the logical channel being one which carries data such as has been discussed previously), where the at least one logical channel is being encapsulated in a PPP link established between the low-processor-load aggregation device 250 and the PC device 108.

Upon receipt of the control information in the Ethernet frame 412, the Ethernet device 226 strips the Ethernet header and passes the VLAN-tagged packet into the multi-channel device 228. The multi-channel device 228 then strips the VLAN tag (e.g., VLAN_3 tag) and hands the residual PPP control information to the appropriate channel unit (e.g., channel unit_3). Thereafter, the channel unit (e.g., channel unit_3) merges the PPP control packets that came from the host processor 202 with the PPP-encapsulated data packets (e.g., those PPP-encapsulated data packets that are created by putting PPP headers on the IP packets received from the host-processor-controlled aggregation-unit-specific routing device 200; those skilled in the art will appreciate that packets (e.g., IP packets) received from the host-processor-controlled aggregation-unit-specific routing device 200, in normal operation, are PPP-encapsulated to provide link control of the data link between the channel unit (e.g., channel unit_3) and the PC device 108). Thereafter, the channel unit (e.g., channel unit_3) sends the PPP-encapsulated data over the PPP link maintained between the channel unit (e.g., channel unit_3) and the network station (e.g., PC device 108).

With reference now to FIG. 4F, shown is the multi-channel device 228 receiving an outbound packet 428 having payload containing PPP contents. The multi-channel device 228 examines the destination address of the outbound packet's 428 header.

The multi-channel device 228 has been earlier configured by the host processor 202 to recognize that the address of the received outbound-packet is associated with either control or data related to a channel over which PC device 108 is communicating, where the PC device 108 is expecting the low-processor-load aggregation device 250 to provide some control functions related to the NCP and LCP control aspects of the PPP protocol. To resolve whether the received packet contains control or data, the multi-channel device 228 looks relatively deep into the payload of the received packet to see if whether the packet contains PPP control information. As shown in FIG. 4F, if the packet does contain PPP control information, the multi-channel device 228 maps the known inbound packet to the host processor, said mapping based on both the network address and the contents of the outbound packet; for example, encapsulating the entire outbound packet in an Ethernet frame 424 having as a MAC destination address that of the host processor 202. However, if the packet does not contain PPP control information, the multi-channel device 228 instructs its attached Ethernet device 226 to map the inbound packet's internet destination address to an Ethernet MAC address associated with the host-processor-controlled aggregation-unit-specific routing device 200, and thereafter send the Ethernet frame out over Ethernet bus 255 (e.g., analogous to the operations shown and described in relation to FIGS. 4C-4D).

Continuing to refer to FIG. 4F, in the event that the received packet was routed to the host processor 202, upon receipt of the control information, the host processor 202 processes the control command, and then communicates (e.g., via either a dedicated path (not shown) or back through the Ethernet switch 204 and the Ethernet bus 255) with the appropriate channel unit (e.g., channel unit_3) to effect whatever control command(s) was contained in the received PPP control packet. In the event that the received packet was a data packet, the system functions substantially analogous to the system described in relation to FIGS. 4C-4D, where data packets were described as being forwarded across the low-processor-load aggregation device 250.

As noted above, throughout the preceding discussion it was assumed that the host processor had already configured the appropriate components to function as described above. Those having ordinary skill in the art will appreciate that in order to configure the appropriate components it is desirable for the host processor 202 to receive control information. How this is accomplished in one implementation is shown in FIG. 5.

d. Exchange of Low-Processor-Load Aggregation Unit Control Information

With reference now to FIG. 5, shown is a high-level block diagram depicting an implementation of a method, in the context of the low-processor-load aggregation device 250, wherein control information is routed to the host processor 202. Referring now to FIG. 5, shown is the standard routing device 210 receiving an inbound-packet 500, where the inbound-packet 500 having a payload 602 of control or unknown contents. Standard routing device 210 examines the destination address of the inbound-packet 500 header, determines from its routing table that the destination address is associated with the attached aggregation device, and consequently routes the inbound packet “downward” to the host-processor-controlled aggregation-unit-specific routing device 200.

The host-processor-controlled aggregation-unit-specific routing device 200 has been configured such that, by default, it encapsulates inbound packets which it does not recognize in an Ethernet frame 510 having the MAC address of the host processor 202 and thereafter transmits the Ethernet frame 510 to the Ethernet switch 204. The Ethernet switch 204 thereafter transmits the Ethernet frame 510 to the host processor 202. Upon receipt of the Ethernet frame 510, the host processor processes the content of the inbound packet 500 containing the control or other unrecognized information via techniques well known to those having ordinary skill in the art.

In some instances, rather than sending the host processor 202 control information directly, it is actually desired that control information be transmitted as associated with a particular channel. One implementation by which this is done is shown in FIGS. 6A-6B.

Referring now to FIG. 6A, shown is a high-level logic flowchart depicting a method and system. The method depicted in FIG. 6A functions substantially analogously as described in relation to FIGS. 3A-3B above, except that when the payload 602 of the inbound packet 600 is ultimately received by the channel unit (e.g., channel unit_2 as shown in FIG. 6A), the channel unit recognizes that the data is not voice data. Accordingly, illustrated in FIG. 6B is that the channel unit passes the payload 602 to the attached Ethernet device 226 with instructions that payload be encapsulated in an Ethernet frame 604 having the MAC address of the host processor 202 and thereafter transmits the Ethernet frame 604 via the Ethernet bus 255.

FIGS. 6A-B illustrated the situation in which inbound control information, associated with a particular active channel, makes its way to the host processor 202. However, in other instances the host processor 202 may want to send control information, associated with an active channel, to the host processor's 202 counterpart (not shown) somewhere in packet-switched network 100 (e.g., such as in a Named Telephony Event (NTE)). FIGS. 7A-7B illustrate how one implementation achieves the foregoing.

With reference now to FIG. 7A, shown is that the host processor 202 causes an Ethernet frame 700, having control information destined for the host processor's 202 counterpart—which not shown, but which is somewhere out in the packet-switched network 100—to be transmitted, via Ethernet switch 204, out onto the Ethernet bus 255. Illustrated in FIG. 7A is that the payload 702 of the Ethernet frame is ultimately received by the channel unit associated with the VLAN tag (e.g., channel unit_2 associated with the VLAN_2 tag), which examines the payload 702 and recognizes that data in payload 702 is not voice data.

Accordingly, illustrated in FIG. 7B is that the channel unit passes the payload 702 to its associated VLAN unit (e.g., VLAN Unit_2, which is illustrated as associated with the channel unit_2), which creates a VLAN-tagged packet 704. The VLAN-tagged packet 704 is then passed to the attached Ethernet device 226 with instructions that the VLAN-tagged packet 704 be encapsulated in an Ethernet frame 706 having the MAC address of the host-processor-controlled aggregation-unit-specific routing device 200 and thereafter transmits the Ethernet frame 706 via the Ethernet bus 255.

Upon receipt of Ethernet frame 706 containing the VLAN-tagged packet 704, the host-processor-controlled aggregation-unit-specific routing device 200 maps the source MAC address of the MAC device 226 from which Ethernet frame 706 originated to its appropriately associated IP address, and maps the VLAN-tag to its appropriately associated UDP (i.e., essentially does the inverse of the function described above in relation to FIG. 3A), and hands the constructed IP packet to transmits the resultant outbound packet 708 to the packet-switched network 100. Upon receipt of such control information, the host processor's 202 counterpart (not shown) will engage in operations substantially analogous to those described in relation to FIGS. 6A-6B, above.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the devices and/or processes via the use of block diagrams, and examples. Insofar as such block diagrams, and examples contain one or more functions and/or operations, it will be understood as notorious by those within the art that each function and/or operation within such block diagrams, or examples can be implemented, individually and/or collectively, by a wide range of hardware, software, firmware, or virtually any combination thereof. In one embodiment, the present invention may be implemented via Application Specific Integrated Circuits (ASICs). However, those skilled in the art will recognize that the embodiments disclosed herein, in whole or in part, can be equivalently implemented in standard Integrated Circuits, as one or more computer programs running on one or more computers (e.g., as one or more programs running on one or more computer systems), as one or more programs running on one or more controllers (e.g., microcontrollers) as one or more programs running on one or more processors e.g., microprocessors, as firmware, or as virtually any combination thereof, and that designing the circuitry and/or writing the code for the software and or firmware would be well within the skill of one of ordinary skill in the art in light of this disclosure. In addition, those skilled in the art will appreciate that the mechanisms of the present invention are capable of being distributed as a program product in a variety of forms, and that an illustrative embodiment of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links using TDM or IP based communication links (e.g., packet links).

In a general sense, those skilled in the art will recognize that the various embodiments described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing systems via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. Note: it will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system comprising:
a low-processor-load aggregation device interposed between a network and at least one network station, said low-processor-load aggregation device having:
at least one multi-channel device, said multi-channel device having at least one internal network tag associated with the at least one network station, and
a host-processor-controlled routing device operably coupled with the network, said host-processor-controlled routing device configured to coordinate at least one network address with the at least one internal network tag associated with the at least one network station.

2. The system of claim 1 wherein the at least one internal network tag associated with the at least one network station comprises:
at least one VLAN tag associated with a channel unit of the at least one multi-channel device.

3. The system of claim 1 wherein the at least one internal network tag associated with the at least one network station comprises:
a channel unit of the at least one multi-channel device maintaining at least one end of a logical channel, a second end of the logical channel maintained by the at least one network station.

4. The system of claim 1 wherein said at least one multi-channel device comprises:
said at least one multi-channel device uniquely coupled with a private-network device having a unique private-network address, said private network internal to the low-processor-load aggregation-unit.

5. The system of claim 4 wherein the private network internal to the low-processor-load aggregation-unit comprises:
an Ethernet-protocol network.

6. The system of claim 4 wherein the private-network device having a unique private-network address comprises:
an Ethernet-protocol device having a unique Ethernet protocol MAC address.

7. The system of claim 4 wherein the internal to the low-processor-load aggregation-unit comprises:
the private network operating over a shared medium, a non-shared medium, or a combination of a shared medium and a non-shared medium.

8. The system of claim 1 wherein the least one multi-channel device comprises:
a channel unit which provides voice processing.

9. The system of claim 1 wherein the low-processor-load aggregation device comprises:
a host processor.

10. The system of claim 1 wherein the low-processor-load aggregation device comprises:
a switch.

11. The system of claim 1 wherein the switch comprises an Ethernet protocol switch.

12. The system of claim 1 wherein the system comprises a minicomputer.

13. The system of claim 1 wherein the network station comprises a network station selected from the network-station group including but not limited to a PC device, a voice device, and a fax device.

14. A method comprising:
coordinating an external network packet with an internal private-network address of a low-processor-load aggregation device.

15. The method of claim 14 wherein said coordinating an external network packet with an internal private-network address of the low-processor-load aggregation device comprises:
coordinating the external network packet with at least one internal private-network address of at least one multi-channel device.

16. The method of claim 15 wherein said coordinating the external network packet with at least one internal private-network address of at least one multi-channel device comprises:
coordinating the external network packet with the at least one internal private-network address on the basis of a content of the external network packet.

17. The method of claim 16 wherein said coordinating the external network packet with the at least one internal private-network address on the basis of a content of the external network packet comprises:
coordinating the external network address with an internal private-network address on the basis of a Voice-Over-IP, Modem-Over-IP, or Fax-Over-IP content of the external network packet.

18. The method of claim 15 wherein said coordinating the external network packet with at least one internal private-network address of at least one multi-channel device comprises:
coordinating the external network packet with the at least one internal private-network address on the basis of a header of the external network packet.

19. The method of claim 15 wherein said coordinating an external network address of the packet with at least one internal private-network address of at least one multi-channel device comprises:
coordinating the external network address with at least one internal private-network device uniquely associated with the at least one multi-channel device.

20. The method of claim 15 wherein said coordinating an external network address of the packet with at least one internal private-network address of at least one multi-channel device comprises:
coordinating the external network address with at least one VLAN tag internal to the at least one multi-channel device.

21. The method of claim 20 wherein said coordinating the external network address with at least one VLAN tag internal to the at least one multi-channel device comprises:
coordinating the external network address with at least one VLAN tag internal to the at least one multi-channel device, where the at least one VLAN tag is associated with a channel unit maintaining a logical channel with at least one network station.

22. The method of claim 21 wherein the network station comprises a network station selected from the network-station group including but not limited to a PC device, a voice device, and a fax device.

23. The method of claim 14 wherein said coordinating an external network packet with an internal private-network address of a low-processor-load aggregation device comprises:
coordinating the external network address with an internal private-network address of a host processor.

24. The system of claim 23 wherein said coordinating the external network address with an internal private-network address of a host processor comprises:
directing at least a part of a packet having the external network address to the internal private-network address of the host processor.

25. The system of claim 23 wherein said coordinating the external network address with an internal private-network address of a host processor comprises:
directing at least a part of a packet having the external network address to a channel unit internal to the internal private-network address of the host processor.

26. The method of claim 14 wherein the internal private-network address comprises:
an Ethernet-protocol address.

27. A system comprising:
means for coordinating an external network packet with an internal private-network address of a low-processor-load aggregation device.

28. The system of claim 27 wherein said means for coordinating an external network packet with an internal private-network address of the low-processor-load aggregation device comprises:
means for coordinating the external network packet with at least one internal private-network address of at least one multi-channel device.

29. The system of claim 28 wherein said means for coordinating the external network packet with at least one internal private-network address of at least one multi-channel device comprises:
means for coordinating the external network packet with the at least one internal private-network address on the basis of a content of the external network packet.

30. The system of claim 29 wherein said means for coordinating the external network packet with the at least one internal private-network address on the basis of a content of the external network packet comprises:
means for coordinating the external network address with an internal private-network address on the basis of a Voice-Over-IP, Modem-Over-IP, or Fax-Over-IP content of the external network packet.

31. The system of claim 28 wherein said means for coordinating the external network packet with at least one internal private-network address of at least one multi-channel device comprises:
means for coordinating the external network packet with the at least one internal private-network address on the basis of a header of the external network packet.

32. The system of claim 28 wherein said means for coordinating an external network address of the packet with at least one internal private-network address of at least one multi-channel device comprises:
means for coordinating the external network address with at least one internal private-network device uniquely associated with the at least one multi-channel device.

33. The system of claim 28 wherein said means for coordinating an external network address of the packet with at least one internal private-network address of at least one multi-channel device comprises:
means for coordinating the external network address with at least one VLAN tag internal to the at least one multi-channel device.

34. The system of claim 33 wherein said means for coordinating the external network address with at least one VLAN tag internal to the at least one multi-channel device comprises:
means for coordinating the external network address with at least one VLAN tag internal to the at least one multi-channel device, where the at least one VLAN tag is associated with a channel unit maintaining a logical channel with at least one network station.

35. The system of claim 34 wherein the network station comprises a network station selected from the network-station group including but not limited to a PC device, a voice device, and a fax device.

36. The system of claim 27 wherein said means for coordinating an external network packet with an internal private-network address of a low-processor-load aggregation device comprises:
means for coordinating the external network address with an internal private-network address of a host processor.

37. The system of claim 36 wherein said means for coordinating the external network address with an internal private-network address of a host processor comprises:
means for directing at least a part of a packet having the external network address to the internal private-network address of the host processor.

38. The system of claim 36 wherein said means for coordinating the external network address with an internal private-network address of a host processor comprises:
means for directing at least a part of a packet having the external network address to a channel unit internal to the internal private-network address of the host processor.

39. The system of claim 27 wherein the internal private-network address comprises:
an Ethernet-protocol address.

40. A method comprising:
coordinating an external network-station packet with an internal private-network address of a low-processor-load aggregation device.

41. The method of claim 40 wherein said coordinating an external network-station packet with at least one internal private-network address of at least one multi-channel device comprises:
coordinating the external network-station packet with the at least one internal private-network address on the basis of a content of the external network-station packet.

42. The method of claim 41 wherein said coordinating the external network-station packet with the at least one internal private-network address on the basis of a content of the external network-station packet comprises:
coordinating the external network-station address with an internal private-network address of a host processor on the basis of a content of the external network-station packet.

43. The method of claim 42 wherein said coordinating the external network-station address with an internal private-network address of a host processor on the basis of a content of the external network-station packet comprises:
coordinating the external network-station address with an internal private-network address of a host processor on the basis of a PPP control command content of the external network-station packet.

44. The method of claim 41 wherein said coordinating the external network-station packet with the at least one internal private-network address on the basis of a content of the external network-station packet comprises:
coordinating the external network-station address with an internal private-network address of a routing device on the basis of a header of the external network-station packet.

45. The method of claim 40 wherein the internal private-network address comprises:
an Ethernet-protocol address.

46. A system comprising:
means for coordinating an external network-station packet with an internal private-network address of a low-processor-load aggregation device.

47. The system of claim 46 wherein said means for coordinating an external network-station packet with at least one internal private-network address of at least one multi-channel device comprises:
means for coordinating the external network-station packet with the at least one internal private-network address on the basis of a content of the external network-station packet.

48. The system of claim 47 wherein said means for coordinating the external network-station packet with the at least one internal private-network address on the basis of a content of the external network-station packet comprises:
means for coordinating the external network-station address with an internal private-network address of a host processor on the basis of a content of the external network-station packet.

49. The system of claim 48 wherein said means for coordinating the external network-station address with an internal private-network address of a host processor on the basis of a content of the external network-station packet comprises:
means for coordinating the external network-station address with an internal private-network address of a host processor on the basis of a PPP control command content of the external network-station packet.

50. The system of claim 47 wherein said means for coordinating the external network-station packet with the at least one internal private-network address on the basis of a content of the external network-station packet comprises:
means for coordinating the external network-station address with an internal private-network address of a routing device on the basis of a header of the external network-station packet.

51. The system of claim 46 wherein the internal private-network address comprises:
an Ethernet-protocol address.

52. A method comprising:
coordinating an external network-station control message with an internal private-network address of a low-processor-load aggregation device.

53. The method of claim 52 wherein said coordinating an external network-station control message with an internal private-network address of a low-processor-load aggregation device comprises:
coordinating the external network-station control message with the at least one internal private-network address.

54. The method of claim 53 wherein the control message comprises a PPP control message.

55. The method of claim 52 wherein the internal private-network address comprises:
an Ethernet-protocol address.

56. A system comprising:
coordinating an external network-station control message with an internal private-network address of a low-processor-load aggregation device.

57. The system of claim 52 wherein said means for coordinating an external network-station control message with an internal private-network address of a low-processor-load aggregation device comprises:
means for coordinating the external network-station control message with the at least one internal private-network address.

58. The system of claim 53 wherein the control message comprises a PPP control message.

59. The system of claim 52 wherein the internal private-network address comprises:
an Ethernet-protocol address.
